(19) United States
(12) Patent Application Publication
(10) Pub. No.: US 2005/0033855 A1
(43) Pub. Date: Feb. 10, 2005

(54) Method and apparatus for generating and marketing video e-mail and an intelligent video streaming server

(76) Inventors: Ahmad Moradi, Ft. Lauderdale, FL (US); Arash Jalali, Ft. Lauderdale, FL (US)

Correspondence Address: FLEIT KAIN GIBBONS GUTMAN & BONGINI, COURVOISIER CENTRE II, SUITE 404, 601 BRICKELL KEY DRIVE, MIAMI, FL, 33131, US

(21) Appl. No.: 10/634,733

(22) Filed: Aug. 5, 2003

(51) Int. Cl. G06F 15/16

(52) U.S. Cl. 709/231; 709/206

(57) ABSTRACT

A method and apparatus for generating and sending video emails containing video and graphics, and optionally text, animation, sound, attachments and links. The graphics are produced as a skin on the computer screen and the video plays in a defined location on the computer screen within, preferably, or without the skin. An intelligent video streaming server stores the video emails and sends them when instructed.

### BACKGROUND OF THE INVENTION

1. Field of the Invention

This invention relates to a method and apparatus for generating and marketing video e-mail and to an intelligent server that can also function as an ad server.

2. Prior Art

Internet advertising and particularly video e-mail are growing at an incredible rate. Today online advertising has reached $6 billion. However rich media which include video and sound remain a small slice with as spending last year of 2% in 2001, according to the Interactive Advertising Bureau and Price Waterhouse Coopers. While online advertising remains minuscule by YV standards, a June 2003 survey of marketing executives by Jupiter Research found that 64% plan to run online video ads in the next 12 months, up from 38% who reported running such ads in the previous 12 months in annual spending. The perception is that businesses are beginning to perceive video and e-mail marketing as the silver bullet for acquisition and retention strategies because it's fast, cost-effective and provides immediate viewing and interactive feedback. As a result, the volume of opt-in commercial e-mails continues to rise at a furious pace.

What can be done with video e-mail marketing appears to be only limited by one's imagination, e.g. whether one uses e-mail to introduce new products, announce upgrades, communicate new prices, trumpet new features or personnel, the list appears virtually endless.

Comparing e-mail marketing to regular mail, radio or television, the response rates for regular mail, radio or television is from 0.5% to 2% whereas it is not uncommon with e-mail video to obtain response rates in the 3% to 10% range. Currently, there is no other marketing that can deliver such a strong result. The Internet user population in the U.S alone is now over 140 million. Surveys of on-line shoppers reveal that more than 40% say e-mail was an important factor in their most recent purchase.

The challenge with e-mailing video on the web has always been file watching the video either universally through a click or automatically based on individual desktop settings populated by various media formats, bandwidth and compatibility. To date all e-mailed video commercials developed require a special player, plug-in and or executables to view it, and none has an ability to play automatically on popular email programs (e.g. Outlook, Outlook Express, Incredimail). Accordingly, there still exists a strong need for a video e-mail that meet the challenge and that can be used effectively as a marketing tool.

### SUMMARY OF THE INVENTION

The present invention provides a method and apparatus for generating and marketing video e-mail and to an intelligent server that can function as an ad server. This is accomplished by the present invention by providing video and sound in one small envelope to create a new vehicle as the basis for e-mail marketing to or for advertisers, businesses and service companies. The generated video e-mail meets the challenge in the art by generating an e-mailing video with an appropriate file size, bandwidth and compatibility. Further, the generated e-mailed video commercial requires no special player to view it, and has a very small file size, of under 800K for thirty-seconds of video when sent as an attachment. The file size of video e-mailing when sent as a streaming work with ad-server is no more than 15K (Kilo Byte). By the advent of the present invention, instead of a text message, the business world can send a video message that offers the dynamics of color, movement and sound. The present invention constitutes a revolutionary marketing and technological product.

The present invention enables the broadcast to the masses of video e-mails, whether working from a client produced video, TV Ad, or a video produced for a client, it is possible to send video e-mails of any thirty-second video content. Thus, businesses, taking advantage of the present invention can now explore new profit centers, increase web traffic, and achieve high impression and response rates while playing to a captive desktop, laptop, wireless and cell or other mobile audience. The present invention allows viewers to watch the best picture quality video with the smallest file size packaged in a dependable format that every Internet user can view. By the method of the present invention a video message is created that is e-mailed to one or more specified e-mail addresses.

Physically, the generated video e-mail message has a very small file size, and therefore, won't clog up the Internet e-mail channels. The average size when sent as a streaming work is no more than 15K while when video is sent as an attachment a thirty-seconds of video is under 800K. The generated video e-mail message is a generic MPEG file which allows it to play to the lowest common denominator of computers. It works easily with Microsoft Media Player®, QuickTime®, Real Player® or any other bundled player. The generated video e-mail can be either a streaming video or non-streaming. Hence when sent as non-streaming, it plays right from the desktop, not from a far away mail server, and does not depend on Internet bandwidth (Server or User) whereas the streaming version requires connection to the Internet and is bandwidth dependent.

A method of the present invention provides many uses for video communications and can be utilized as B-to-B, i.e. business to business or as B-to-C, i.e. business to consumer, e.g. to introduce a new hit movie or inform stockholders of great news. It can promote or sell just about anything through direct response, image or entertainment based campaigns. Essentially, the method generates a video e-mail on behalf of a client that is like an envelope. The envelope has a front page complete with series of links to a highlighted website and actions (e.g. e-mail addresses, coupon page). The envelope also contains additional provisions to include important or timely information for coupons or disclaimers, as well as, the commercial, links and/or pages. The envelope can be custom built to meet the needs of any client.

The invention offers a valuable solution for businesses, agencies, list providers and any other company involved with e-mail marketing. A video e-mail can be made from an existing TV commercial or any video content. The invention also provides a way to produce a video e-mail from concept to completion.

The invention further provides a novel intelligent video streaming server to provide facilities for ISP's and media streaming hosts that is more versatile than currently available streaming servers. The novel inventive intelligent video streaming server acts as a control panel through which services can be provided to clients both for administrative purposes of uploading video. Whereas nearly all major streaming servers come with an administration panel, which is in most cases web-based, and can be used remotely, what is really needed are controls that would make available a uniform platform for managing thousands of users; that would enable ease of management of their users no matter which type of streaming video format is being used; that would continue to work or function effectively even if the user were to change its streaming video format half way through; that would enable their users to upload and manage their multimedia files through a standard browser, like IE and Netscape, and seamlessly use the features of the underlying streaming servers without regard to the technical know-how's of a specific streaming server; that would be available under most major platforms, i.e. Windows and Linux, and would work with major codex formats, such as, Real Networks, Apple Quick Time, Windows Media, Macromedia Flash and MPEG; and that would allow simultaneously use of multiple streaming video formats and have the intelligence to redirect viewers each time to the streaming format and the content that best fits the viewer's player, desktop settings, and network configuration. These are the attributes and advantages of the novel intelligent streaming server of the present invention.

As an example to illustrate the versatility and functionality of the novel intelligent streaming server of the present invention, the novel intelligent streaming server can play the role of an Ad server for any customer wishing to promote or announce new products or services.

The invention relates to a method and apparatus for marketing a video email including the production of a video email. The generation of a video email comprising one or more of the following steps. Providing a video for display on a computer screen. Providing a skin for display on a computer screen. Correlating the video and the skin positions in a pre-selected matrix to display on a computer. Providing Sender's email address. Providing Subject Heading for broadcasting video email. Providing Reply Address as an alternate email address for correspondence (other than the Sender's Address). Providing User defined Action Labels in form of text or image connecting to links, email address, web pages, and IP addresses. Providing links to skin or image file. Providing link to a Intelligent Video Streaming Server for integrated access and uploading a video file. Providing link to the Intelligent Video Streaming Server for integrated access and uploading of Skin image or animated file. Providing link to the other IP addresses or web sites for placement of a video file. Providing link to the other IP addresses or web sites for placement of Skin image or animated file. Providing ability to fetch and display the Skin from Intelligent Video Streaming Server, designated IP Address, or a web site.

According to the invention the placement of skin (image) may comprise one or more of the following steps. Providing links to Skin (Image) file(s)—an input defining the location of the Skin (Image) file(s). Providing link to the Intelligent Video Streaming Server for integrated access and uploading Skin (Image) file(s). Providing link to the other IP specific addresses or web sites for entering the location of the Skin (Image) file(s). Providing ability to fetch and displaying the Skin (Image) from Intelligent Video Streaming Server, designated IP Address, or a web site. Providing ability to increase or decrease the width or length of the fetched Skin (Image) on screen fitting a suitable user's need. Providing ability to scroll the Skin (Image) on a computer screen. Providing an expandable rectangular box covering a specific area or all Skin (Image) surface for hyperlink to a URL address (Web site address).

According to the invention placement of Video Clip may comprise one or more of the following steps. Providing provisions for the video playing automatically when the email arrives in a mailbox. Providing provisions for the video to be sent as an attachment. Providing provisions for the video playing automatically within the Skin (Image) file as its position defined on a computer screen by the video email sender. Correcting the video and Skin (Image) in a pre-selected screen format identifying desired location for video playing on video email. Providing provisions for the video playing automatically when email recipient clicks on a designated area of the Skin (Image) File as defined by video email sender. Creating a method for video popping up on a computer screen and playing automatically. Setting an alternate method of video playing on a pop up screen in the event video email recipient's computer and desktop settings prohibiting automatic playing of the video. Providing provisions for the video playing automatically when email recipient clicks on any specified area of the Skin (Image) File including all designated area of Skin (Image) as specified by video email sender popping up on a computer screen and playing automatically. Establishing authorized authentication, direct connection, and video access through Intelligent Video Steaming Server for uploading of video file(s) to Intelligent Video Streaming Server. Providing automated link and its automatic paste entry of video streaming code from Intelligent Video Streaming Server into video clip input field. Providing input link to other IP specific addresses, streaming servers or web sites where video file is located for entering designated location of video file(s). Providing ability for input link to video files based on formats available from: Microsoft Media Player Format, Real Network's Real One Formats, Apple Quick Time Formats, Motion Picture Expert Group (MPEG) Formats, and Macromedia Flash Formats. Providing variable video formats for broadband and modem connection and broadcasting streamed from Intelligent Video Streaming Server, designated IP Address, video streaming servers or a web sites. Providing capabilities for secured and firewall sites to view video. Providing exception rules for unified display of video email for public (POP) email account sites such as but not limited to Yahoo, Hotmail, AOL, MSN, and other public email sites limited to Internet browser access only. Providing provisions for video access on a computer screen when video email recipient program does not support scripted programming language displaying video on a computer screen. Capability of showing hyperlinks to designated video locations where no known video format or player is installed on video email recipient's computer disk or prohibited by desktop settings. Creating an input text field of instruction inputted by video email sender as a method of instructing email recipient accessing video in the event there were no known video formats or video player installed on recipient computer disk and desktop settings. Creating an input image field of instruction inputted by video email sender as a method of instructing email recipient accessing video in the event there were no known video formats or video player installed on recipient computer disk and desktop settings.

According to the invention placement of attachment may comprise one or more of the following steps. Sending and receiving attachment files of any size. Locating a attachment file in any disk storage media format including network systems. Ability to store attachments as a list for immediate, future adding or deletion when sending a video email.

According to the invention Importing email addresses may comprise one or more of the following steps. Creating a user manual input of email accounts. Establishing a test email account for testing and viewing on a computer screen. Importing email accounts from Plain Text, Microsoft Excel, Microsoft Access, Open Data Base Compliance (OBBC) data sources, Microsoft Outlook and Outlook Express, Microsoft Word, and other formats supporting ASCII files with and without delimiters as a method separating fields of information such as name, address, email from one another. Customizing step-by-step Wizard for Plain Text, ASCII, Excel, Access, and ODBC data source (automated program) helping import of such data becoming simple and easy. Exporting such email list (once imported) as Plain Text and ASCII file format for future ease of use and downloading into video emailing system.

According to the invention creating, adding, editing, saving, printing, deleting, importing, and exporting a video email code may comprise one or more of the following steps. Managing and generating computer codes in various formats but not limited to HTML, JavaScript, XML, and other machine usable codes for use on display on computer screen. Generating Automatic Code for ease of use and transmission (broadcasting) of video email to recipient(s). Providing provisions to add, edit, modify, copying, printing, deleting and making changes to automatically created computer generated video email code for additional customization and conditional improvement as video email sender deems necessary. Saving such code in both automated or custom version form in HTML, XML and other machine generated computer language code formats for future use and archival. Importing such code in formats not limited to HTML, XML and other computer generated code for future use and broadcasting on a computer screen.

According to the invention sending a video email may include one or more of the following steps. Sending one video email per recipient. Sending multiple recipients in a Blind Carbon Copy (BCC) format for bulk mailing. Setting video email user defined parameters specifying:
a. the number of recipients bulked (grouped) together where value zero is regarded as all recipients.
b. the number of seconds intervals between each transmission ranging from 1 second to any value send of video email defines.
c. the number of sequential bulk sent at any given time ranged from 1 to any value specified by the video email sender.
d. resetting the number of bulk sent after connection to the SMTP server. This value is also defined by the video email sender.

The invention further contemplates displaying feedback for video email comprising one or more of the following steps. Creating confirmation of successful transmission of sent email. Displaying errors of unsuccessful transmission of sent email along with its reasoning. Showing related statistics about sent video email.

The invention further contemplates creating an automatic method for setting up video email settings comprising one or more of the following steps. Creating a step-by-step wizard helping video email sender. Getting introduced and acquainted to the procedure. Setting up SMTP, POP3 and Authorized Email Addresses. Setting up and verifying POP3 User Name, POP3 Password, and Reply Email Account. Customizing the settings for the video email sender to:
a. Not connecting to POP3 Account
b. Logging on to the SMTP Server using:
c. The same user name as the POP3 Account
d. Logging on as a different user with different password.
   Finalizing the settings by testing the parameters and verifying all accuracies. Displaying any and all inaccuracies for video email sender correction.

The invention further provides an Intelligent Video Streaming Server that functions comprising one or more of the following steps. Establishing an intelligent scoring algorithm playing the right settings of video for a video email recipient or a web browser. Establishing a gateway to access Intelligent Video Streaming Server from an Internet browser or through the video email generator programming method. Setting up security settings for parties, e. g. Client, Franchisee and Franchisor, to access content based on their level of authorization and access. Defining user ability to access the secured site by properly entering user identification and password driven input identifying client's access to the site. Allowing client managing, video, audio, animation, and images. Allowing client or franchisee or franchisor to edit and change the password settings by entering the old password, and entering the new password and confirming the new password once more. Allowing client to create video, audio, and image folders limited only to disk space. Allowing video formats defined by Administrator (Franchisor) assigning type of video extension that would be permitted for uploading and streaming. Allowing audio formats defined by Administrator (Franchisor) assigning type of video extension that would be permitted for uploading and streaming. Allowing image formats defined by Administrator (Franchisor) assigning type of video extension that would be permitted for uploading and streaming. Allowing renaming the video, audio, and imaging folders by client, Franchisee and Franchisor (Server Administrator). Allowing client, Franchisee, and Franchisor deciding the most optimal automatic playing decision criteria by using a scroll bar. Defining the best video, audio and image viewing experience measured against one extreme of best quality video versus optimized download speed. Displaying on computer screen client, Franchisee or Franchisor control panel for managing video, audio and image files. Creating a method for defining an introduction of animation file. Displaying a method of animation before the video, audio and image is displayed on a computer screen. Displaying on a computer screen a usage quota system showing allocated disk space versus the actual use of the disk space. Storing multiple video contents based on different settings supported by media player formats including but not limited to:
a. Microsoft Media Player
b. Real Networks Real One
c. Apple Quick Time
d. MPEG
e. Macromedia Flash
   Converting a video into several formats and storing them into a folder located at Intelligent Video Streaming Server. Establishing a secured upload of files by selecting the association of video, audio, and image type with the media format. Automatically creating an intelligent detection computer code that when incorporated into video email sender it could use the mathematic algorithm of quality versus speed and stream for most suitable video, audio, and image for email recipient experience. Automatically creating an intelligent detection computer code that when incorporated into web site the browser of the pages could watch the best video, audio settings based on mathematic algorithm of quality versus speed and stream most suitable video for email recipient experience founded on general principle of assigning values to speed, bandwidth connection, media format and creating a “Certainty Factor” a unit of measure that may have several possible alternatives where the highest computational variables associated with video format, connection speed, desktop settings and user preferences will be streamed or emailed for viewing experience on a computer screen. Searching and browsing capability finding local and network media disks locating video, audio and image file(s) for uploading to Intelligent Video Email Streaming Server. Displaying on computer screen, successful uploading or failure reasons. Creating formats for web hosting where web site owners could choose the method of presentation:
f. Intelligent Pop-up video, audio, and image.
g. Using client desktop settings and media player
h. Playing video from within a web page along side with other text and images.
i. Using computer language codes such as HTML, JavaScript, XML to display video, audio, and image.

In addition to the above, the invention may comprise one or more of the following steps. Allowing Client, Franchisee and Franchisor setting up macro and micro rules with the expert system of Intelligent Video Streaming Server for default size of video display. Permitting Client, Franchisee and Franchisor turning on and off the navigational buttons for the video (e.g. rewind, play, pause, fast forward). Permitting Client, Franchisee and Franchisor sizing the video as default settings or changing the display setting for each video folder. Permitting Client, Franchisee and Franchisor to adjust the video on a computer screen by increasing its width and length. Establishing a default time-out value where if Client and Franchisee screen displayed on a computer screen is unattended, it would exit out and roll back to properly entering user identification and password.

Still further, the invention may comprise one or more of the following steps with respect to the Intelligent Video Streaming Server Administrator. Entering into Intelligent Video Streaming Server (IVSS) with administrative user identification and password. Setting up administrative configuration for each apparatus (server). Adding one or many servers to Intelligent Video Streaming Server (Server Farm). Defining Base TCP Port Numbers. Allowing Base and Authorized TCP Port Numbers work with firewall settings and structure. Setting Home Directory for managing parties, e.g., Clients and Franchisees. Establishing a default storage disk space allocation as macro rule for the algorithm engine. Changing the default storage disk space to desired size requested by Client and Franchisee. Using DNS Registering ability at Administrative choice with value defined by network and Intelligent Video Streaming Server administrative settings. (e.g. client.nsiv8.com). Defining a naming registry for secured access by administrator and registering such name with domain name registry (DNS), example: www.nsiv8.com. Establishing a use of database format for storing Client, Franchisee records. (e.g. SQL Server, Oracle). Accessing the IVSS Administrative features through panel control system. Adding, editing, deleting, Client information to Intelligent Video Streaming Server. Monitoring the use of active and inactive Clients and the use of their allocated quote on disk space and bandwidth. Searching Client by User ID for easy find. Entering User ID as alphanumeric character assigned by parties, e.g., Client, Franchisee and Franchisor (Administrator). Adding user identification, password access. Assigning a specific port use to Client or using a custom defined naming convention (yoursite.customers.nsiv8.com) provided “yoursite” name is unique and has not been registered by another user. Creating a home directory where the video, audio, animation and images will reside. Allowing file extensions where the use of video, audio, animation and images would be limited to those extensions granted by the Franchisor (Administrator). Establishing a disk space use for the Client, Franchisee use. Defining bandwidth allocation for Client and Franchisee where value of “−1” would provide unlimited bandwidth access. Establishing a default time-out where if administrative screen displayed on a computer screen is unattended, it would exit out and roll back to Franchisor (Administrative) user identification, and password.

The invention further contemplates storing video on the server comprising one or more of the following steps. Accessing Intelligent Video Streaming Server through standard web browsers. Entering proper identification as Client, Franchisee, or Franchisor (Administrator) accessing authorized location. Creating, editing and deleting folders by Client, Franchisee, and Franchisor (Administrative) for storing, video, audio, animation, and images. Establishing a naming convention where the initial name starting with key identifier provides provision for algorithm engine learning video is meant for special broadcasting and emailing provision (e.g. broadband, wireless, & modem). Establishing a naming convention where the second portion of the naming methodology provides provision for algorithm engine knowing media player it would require for streaming or emailing. Defining a naming convention where the third portion of the naming sequence provides provision for algorithm engine knowing the name of video for streaming or emailing. Providing a naming provides provision for algorithm engine knowing the video format requiring for streaming or emailing. Applying the naming knowledge into algorithm, engine and creating a computer generated code displayed on a computer screen. Creating automatic URL based code where such code can be used by Client for video web hosting using Intelligent Video Streaming Server or placing it into video emailing system for delivering to email recipient.

The invention also contemplates computing the user's best viewing protocol comprising one or more of the following steps. Defining a scoring system for viewing video format. Feeding the value of the scored to algorithm engine(s) for measuring the highest probability value also known as “Certainty Factors”. Creating a scoring methodology for speed and bandwidth connectivity and establishing the Certainty Factor. Establishing scoring values for associating file format extension to the media player located at viewing computer settings hence defining Certainty Factor values. Measuring wrong media format association with a media player in form of conformity will produce the least Certainty Factor value system. Measuring right media format association with right media player produces the highest Certainty Factor value for conformity. Placing Certainty Factor values into algorithm engine(s) and creating decision criteria. (e.g. sending the highest valued video for streaming or emailing). Defining connection speed methodology where value is referred to as raw speed. Creating a file size assessment computation where such value is referred to as bias factor. Taking into account the raw speed and bias factor and defining a score setting using algorithm engine(s) for its most suitable viewing on a computer screen. Converting those values into machine code language for its placement into hosting web sites streaming from IVSS or placing such machine code parameters into video emailing for broadcasting to email recipient.

The invention further contemplates viewing intelligent video for an Internet Browser comprising one or more of the following steps. Invoking web browser program form a computer. Being online through use of TCP/IP or Internet. Entering a web site that uses IVSS for its video streaming. Clicking on an icon supplied by Franchisee or Franchisor to play the video.

The invention also contemplates viewing intelligent video by email recipient comprising one or more of the following steps. Accessing email program. Accessing web based email programs hosted online. Being an authorized user with password. Being online through use of TCP/IP or Internet. Sending and receiving email. Setting security option to “Internet” browsing.

The invention further contemplates apparatus to carry out the functions enumerated above with respect to the method invention.

Other and further objects and advantages of the present invention will become apparent from the following detailed description of preferred embodiments of the invention when taken in conjunction with the appended drawings.

### BRIEF DESCRIPTION OF THE DRAWINGS

FIG. 1a is a special organizational chart for a franchise method of doing business that is typical for the present invention.

FIG. 1b is a flow chart of the marketing process of the present invention as used by a franchisee.

FIG. 2 is a flow chart showing the inputs for generating a video e-mail according to the method of the present invention.

FIG. 3 is a flow chart showing the steps involved in the video and skin pre-production according to the present invention.

FIG. 4 is a flow chart showing the steps involved in the alternative low cost graphic and video production according to the method of the present invention.

FIG. 5 is a flow chart showing the steps involved in the post-production and email delivery using the novel video e-mail generator method and the intelligent video streaming server method and apparatus of the present invention.

FIG. 6 is a flow chart showing how the commercial e-mail generator of the present invention sends out e-mail.

FIG. 7 is a flow chart showing how the intelligent video streaming server performs the novel algorithm of the present invention to determine and select the appropriate video to send.

FIG. 8 is a block diagram of a generic computer system as can be used in the present invention.

### DETAILED DESCRIPTION OF PREFERRED EMBODIMENTS OF THE INVENTION

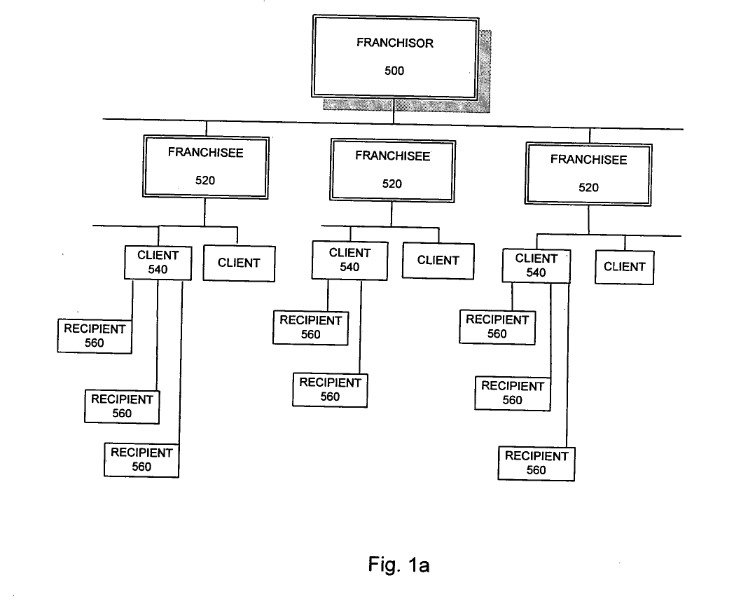

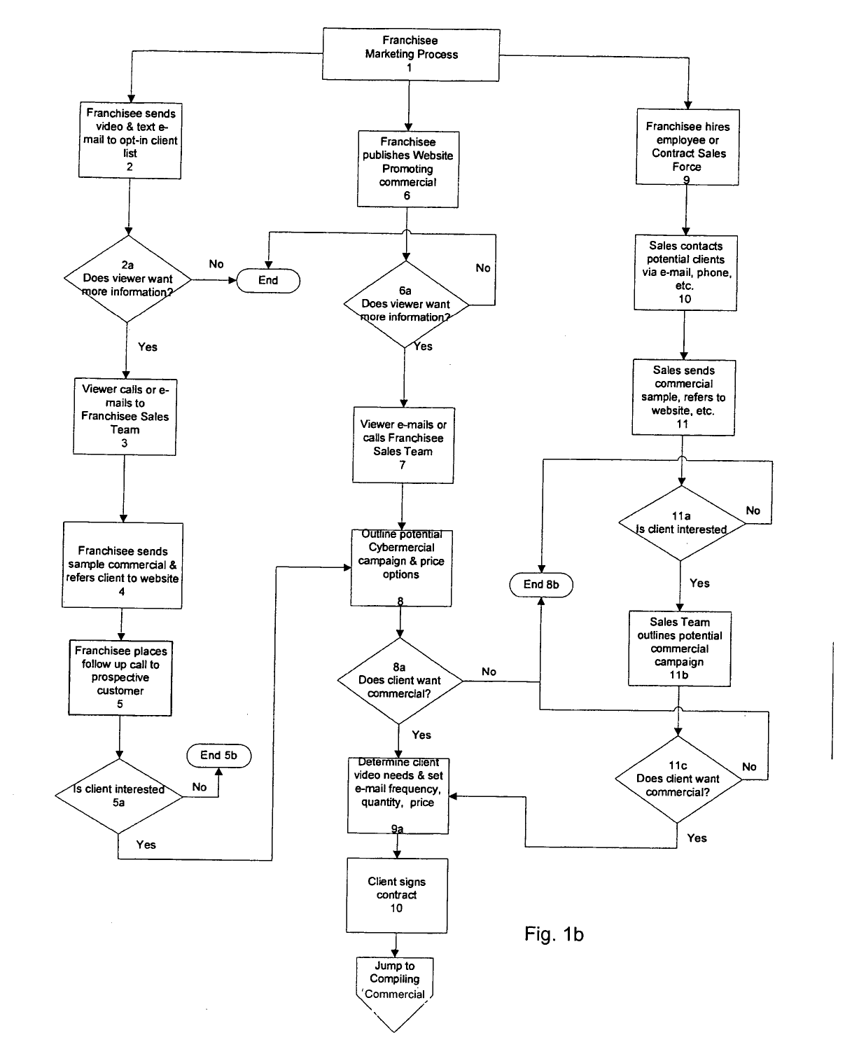

The present invention will now be described in detail with reference to the appended drawings. The business method to which the present invention pertains concerns services and products that are being marketed by a host company that owns or controls or has a proprietary right to the technology of the invention used in the generation of the service or products. The host company or first party, acting at the origination of the service trade level, contracts with second parties who function at a wholesale trade level of the service, and can be franchisees, resellers, agents, distributors and the like companies or individuals. In turn, the second parties, usually operating in exclusive geographical area or fields of use market the host company's services and products by contracting with third parties who are functioning at the retail trade level, and are normally businesses wishing to sell their products or services to either businesses or consumers, who are designated as fourth parties, and more specifically as recipients. The recipients are the targets of the video e-mails generated using the first party's services and products. Hereinafter in order to provide a clearer understanding of the business method disclosed herein, the description will proceed by specific example by describing the transactions with respect to a franchise activity. However, it should be clearly understood that the business model used by example, franchise, in no way is limiting and the organization of the first to fourth parties in the practice of the present invention can take any known or to be created business form or organization. FIG. 1a shows the organization of the franchise activity. Block 500 is the Franchisor, the first party, who owns or has the proprietary right to use the technology of the invention. The Franchisor contracts with a plurality of Franchisees, second parties, in blocks 520 usually predicated on exclusive geographical areas. In turn, each Franchisee contracts with Customers or Clients, third parties, in blocks 540 who are primarily businesses, but may be individuals or partnership proprietors, that are interested in selling their goods and services to the public (consumers) or to other businesses, fourth parties, referred to herein as recipients, see blocks 560. The recipients are the targets of the video e-mails generated by the present invention.

Referring now to FIG. 1b, the description will proceed with respect to a flow chart which shows the marketing process of the present invention as employed by the Franchisee. The flowchart illustrates the marketing and sales channels used by a Franchisee dealing with a number of customers or clients. In order to implement the specific example of the present invention, and enable a clearer understanding, the following explanation will be given with reference to the following business organization. Clients or customers contract with Franchisees (or marketers) for the services provided by the Franchisor. Through the contractual arrangement between the Franchisor and its Franchisees, the Franchisees offer to the public or to a preselected group of potential users the services to generate video e-mails for advertising and/or promotion, usually as commercials, and also to use the services of the Franchisor regarding the intelligent video streaming server. The franchise marketing process, as between the Franchisee and its customers or clients, is illustrated as a concrete example of the present invention to show its applicability to mass marketing. This activity is shown in Step 1 where a Franchisee who has contracted with the Franchisor, wishes to offer the available services to potential or prospective clients or customers (hereinafter collectively “clients”). As shown in Steps 2, 6 and 9, the Franchisee has a choice of three primary marketing channels for accomplishing the marketing of the Franchisor's services and products. In Step 2, the Franchisee can send video and text e-mail to Opt-In, permission based lists of potential clients to generate sales of the novel video e-mail service and product. In Step 6, the Company/Franchisee has the option to publish a website on which the novel video E-Mail is promoted, and generate sales in this fashion. In Step 9, the Franchisee can hire employees or contract with an outside sales force or group to effect direct marketing of the video e-mail of the present invention.

In Step 2, the procedure is that each potential client makes contact with the Franchisee as a response to the solicitation in the video and text e-mail, or is contacted by a Franchisee representative, via telephone, E-Mail, face to face or a web link for “More Information.” In Step 2a, a decision is made whether the client (viewer) wants more information or is disinterested at the moment. If the answer to the decision is NO, then the program ends. On the other hand, if the answer to the decision in Step 2a is YES, and the client or viewer responds by either making a telephone call or by a response e-mail to the Franchisee or any person working with or for the Franchisee, as in Step 3, then, the program advances to Step 4, and the Franchisee sends a sample commercial and refers the potential customer to the website. In Step 5, the Franchisee places a follow-up telephone call to the prospective customer in an effort to determine the customer's interest level. In Step 5a, a decision is made regarding the client or customer's interest level, and if the answer to this decision is NO, and there is no interest, the program advance to Step 5b and ends. On the other hand, if there is a sufficient level of interest and the answer to the decision in Step 5a is YES, the program advance to Step 8 and processing of the client or customer begins in earnest.

As noted, one option is for the Franchisee to publish a website and promote the services for video e-mail commercials to the public in this fashion, and this occurs in Step 6. In Step 6a a decision is made whether or not a viewer of the website is interested in more information. If the answer to this decision is NO, then the program ends. If the answer to the decision in step 6a is YES, and the client wants more information, by the viewer emailing or calling on the telephone or otherwise contacting the Franchisee, as in Step 7, then the program advances to Step 8 and processing of the client or customer begins in earnest.

The third alternative for the Franchisee is to establish a sales capability by hiring employees directly or outsourcing by contracting with an independent sales force, as shown in Step 9. In Step 10 the sales group contacts potential clients or customers via e-mail, phone, fax, etc. For any response, a member of the sales team sends a commercial sample consisting of a video e-mail and refers the potential client to the website for further information in Step 11. In Step 11a, a decision is taken whether the prospective client who has expressed some interest has a sufficient level of interest to carry the process further on. If the answer to the decision is NO, the program goes to Step 8b and ends. If the answer to the decision is YES, then the program advances to Step 11b where the Sales Team outlines a potential commercial video e-mail campaign to promote the client's business of selling goods or providing services. In Step 11c, a decision is taken whether the client is interested enough to want the commercial video e-mail. If the answer to the decision in Step 11c is NO, the program proceeds to Step 8c and ends. If the client wants the commercial video e-mail for its business, the program proceeds to Step 9.

For clients who have expressed sufficient interest in Steps 5a and/or 6a, the program has proceeded to Step 8 where the potential commercial video e-mail campaign is outlined to the client. A sample commercial is e-mailed to the potential customer, customized by the intelligent video streaming email technology of the present invention, as will be explained in detail hereinafter, for the best possible viewing experience on their desktop.

In Step 8a a decision is taken whether the client is interested or not in the proposed commercial as a business tool to be distributed to the client's customers. If the answer to this decision is NO, then the program proceeds to Step 8b and ends. If, on the other hand, the answer to the decision in Step 8a is YES, then the program proceeds to Step 9a where the client's needs are assessed in detail, the quantity of video e-mails and the price are determined. A follow-up contact is made by a sales person and details of a potential campaign are outlined to the client. Such details might include the benefits of video E-Mail for marketing, communications, product sales, etc. Campaign scope and cost will also be discussed. For clients who are genuinely interested, specifics of the commercial message, volume of E-Mail, duration of campaign and actual charges will be outlined.

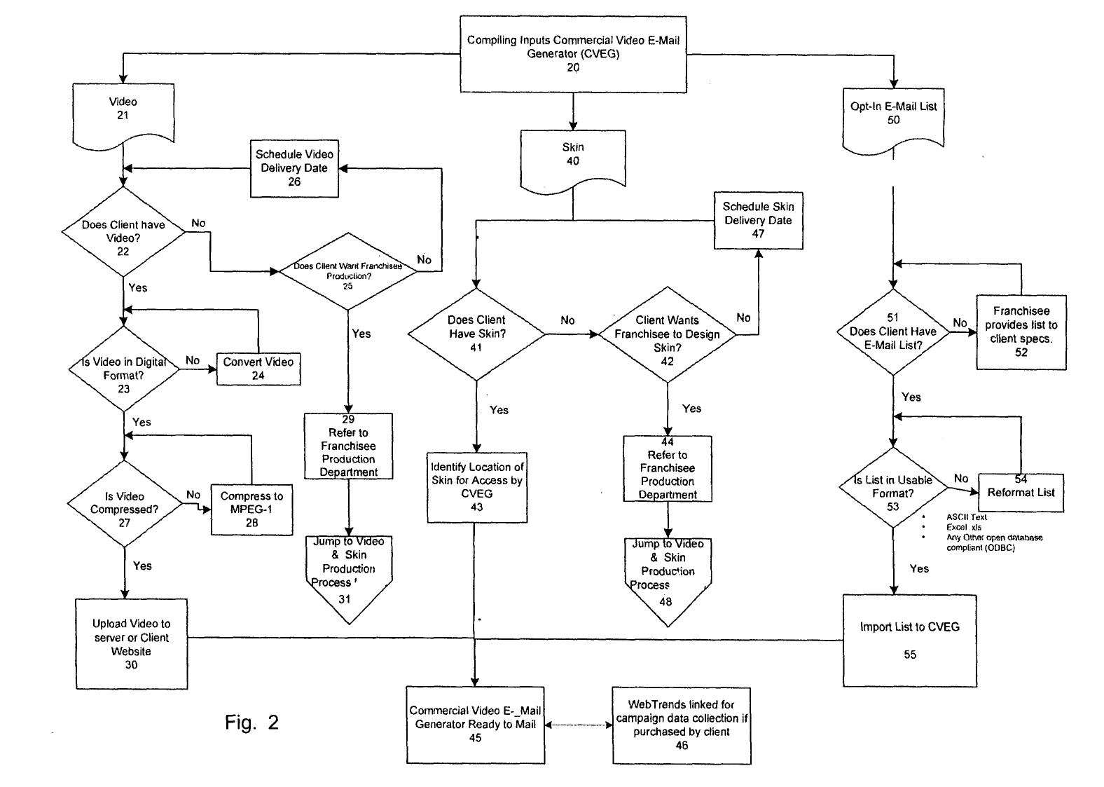

Based on the activity in Step 9a, the program moves to Step 10 and a contract is negotiated and signed between the client and the Franchisee. The client sign a contract for a commercial campaign specifying all requirements including the campaign theme, type of commercial, volume of E-Mail, need for campaign results reporting, timeline for delivery of video, graphics, source of E-Mail list etc. Then the program jumps to that portion of the program for compiling the video e-mail, see FIG. 2.

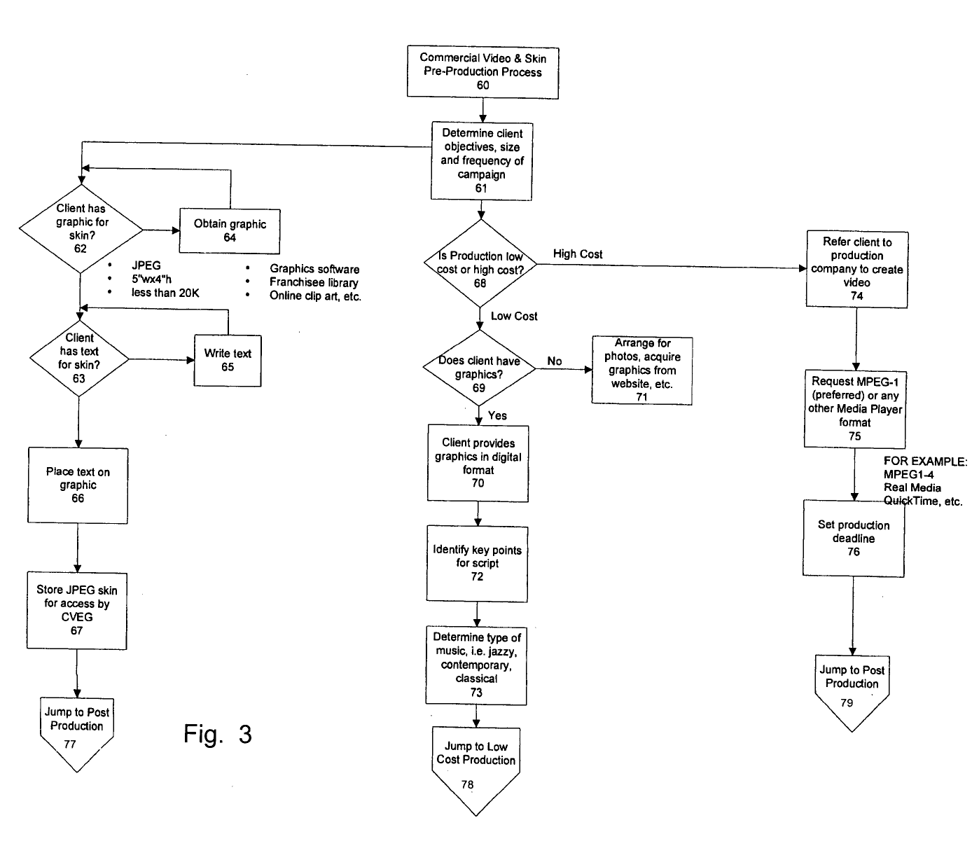

Referring now to FIG. 2, the client's commercial campaign will be initiated by the compiling of the inputs necessary for the Commercial Video E-mail Generator (CVEG) to create or generate the video e-mail to be used in the commercial campaign. The compiling of the essential inputs will now be described in detail starting in Step 20. The flowchart of FIG. 2 provides an overview of the three components necessary for CVEG to deliver commercials, i.e. the pre-recorded video, the skin and the Opt-in E-Mail list. In Step 21 the video input is initiated. The commercial value of this invention centers around the efficient, seamless delivery of a video message in a small file size customized for each and every viewer's desktop. The video can be of any duration, should be designed to entertain, create interest, convey information, sell and prompt the viewer to action such as viewing a website, redeeming a coupon, etc. In some cases, a client may already have a video they wish to use in the campaign. Or, the client may require creation of a new video that they can provide or the Franchisee or a third party can produce. In any event, the video must be of the desired duration, often thirty seconds, and in standard digital file format. The foregoing information is obtained in the decision of Step 22, where the client's possession of a video is decided. If the answer is NO, a subsidiary decision is taken in Step 25 whether the client wishes the Franchisee to make the video or not. If the answer to this decision is NO, then the program moves to Step 26 where the delivery date of a video to be supplied by the client is scheduled, and the program loops or goes back to decision 22. If the answer in Step 25 was YES, then the program proceeds to Step 29 and the matter is referred to Franchisee's production department, and then to Step 31 where the program jumps to Video and Skin Production Process shown in FIG. 3.

The video, whether supplied or produced, may be in any common digital format such as Windows Media Player (.e.g. .AVI. ASF, WMV,), Real Media (.ra, .rm, ram), Apple Quick Time (.mov) or Macromedia Flash (.flv). Moving Picture Experts Group provides a format (e,g. MPG, .MPEG, MPEG-1, 7) that allows encoding and delivery of audio/video content over a variety of networks to PCs, wireless devices, Web browsers and more. If the client is supplying the video, it must either provide the file in a useable format or arrange for conversion. The client may provide the video in AVI and the conversion can be effected by the Franchisor or Franchisee.

The foregoing is determined in the decision taken in Step 23 to determine if the video is in digital format. If the answer is NO to the decision taken in Step 23, then the program proceeds to Step 24 where the video is converted to digital format and the program returns to Step 23. The program proceeds to Step 27 where a decision is taken regarding whether the video is compressed. If the answer is NO, then the program proceeds to Step 28 where the video is compressed to several media format including but not limited to MPEG-1, MPEG-4, .WMA, .RM, QT, SWF, and the program returns to Step 27. When the answer is YES, the program proceeds to Step 30 where the video is uploaded to the intelligent video streaming server of the invention or to the client's website and the data necessary for the CVEG to retrieve or fetch the video is supplied to the Franchisor directly or through the Franchisee and recorded in CVEG or the intelligent video streaming server both of which are under the control of the Franchisor. When sent as a non-streaming envelope, the compressed video is reduced to a relatively small file size, usually 400-800K, and this can be accomplished using any of the readily available technologies including freeware downloads. If the video e-mail is sent as a streaming work and as noted, once the video is in compressed into most popular digital standard formats, they are uploaded to the inventive server (to the customer's own designated storage area) and an intelligent link (HTML Code) is provided for the customer's website for delivering intelligent video streaming and or delivery of video e-mail by the CVEG to the recipient.

A “skin”, that is, a background graphic frames the commercial video, and has text superimposed on the background graphic. The video is played inside a “box” surrounded by the skin. The skin should be 5″ wide by 4″ high. Text conveying the client's name, contact information, website, special offer, etc. should be placed on an appropriate graphic background and saved as a .jpeg file, 30-40K in size. Thus starting in Step 40 the initializes the creation and storage of the skin. First, the program makes a decision in Step 41 concerning whether or not the client has a suitable skin. If the answer is NO to this decision, the program moves to Step 42 to determine in another decision whether the client wants Franchisee to design the skin. If the answer to this decision is NO, the program moves to Step 47 and the skin delivery date is scheduled. When the skin arrives the program returns to Step 41 and continues. If the answer to the decision in Step 42 is YES, the program advances to Step 44 where the making of the suitable skin is referred to the Franchisee Production Department, and thereafter in Step 48 where the program jumps to the Video and Skin Production Process shown in FIG. 3. Going back to Step 41, if the answer to the decision is YES, the program advances to Step 43 where the skin is stored and the location is identified for access by the CVEG. The .jpeg skin must be stored in a location accessible over the Internet, such as, in the intelligent video streaming server of the present invention in the client's designated area in memory, or in any other location (server) accessible over the Internet, with the path recorded for input to CVEG. Like with the video, preferably, an intelligent link (HTML Code) is provided for the client's website for delivering the skin by the CVEG to the recipient.

As part of the process, the Opt-In E-Mail list must be identified. This aspect of the process or method is initialized in Step 50. In Step 51 the decision is taken whether the client has its own E-Mail list. The client may provide their own list based on addresses provided by its customers or the client may choose to use an appropriate permission based list from Franchisee or Franchisor. If the answer in Step 51 is NO, then the program moves to Step 52 and Franchisee provides the E-Mail list to client's specifications, and the program loops back to Step 51. On the other hand, if the answer to the decision in Step 51 is YES, the program continues to Step 53 where the decision is taken whether the list is in useable format. Regardless of the E-Mail list source, the list must be available in a useable format. Acceptable options include any ODBC (Open Database Connectivity) compliant source, such as, ASCII text, Excel spreadsheet, Microsoft Access, Outlook or any other open data base compliant format, delimited, one address per line. If the answer to the decision in Step 53 is NO, the program diverts to Step 54 where the list is reformatted. The program returns to Step 53. If the answer to the decision taken in Step 53 is YES, the list in useable format is forwarded to Step 55 ready for import to the CVEG in Step 45. The Opt-In E-Mail list is either manually input or a file is imported to the CVEG in Step 55.

The Commercial Video E-Mail Generator (CVEG), under the exclusive control of the Franchisor, is set up with the necessary links to the video from Step 30 and skin from Step 43 so each E-Mail address in the Opt-in E-Mail list will have the appropriate commercial delivered to the recipient's desktop (computer). From the knowledge of the disclosure herein, how to effect the linking of the video and skin using the HTML code links and how to forward to each recipient on the list will be apparent to persons skilled in the art. As noted, the video and/or the skin can be in the intelligent video streaming server, from which its retrieval is easily made by the CVEG. However, the video and/or the skin may be stored on any server, such as client's or Franchisee's server or any third party server, in which case, the CVEG requires the necessary information to know where the video and/or the skin is stored to be able to provide the necessary HTML code links for fetching or retrieving, via the Internet, for delivery to the recipient's computer. Also, some clients may choose to associate back end reporting systems such as WebTrends reports with their commercial campaign. In such cases, data will be collected on such things as the total number of E-Mails sent by CVEG, the number delivered, the number opened, etc. This data is stored in a server and linked to the CVEG in a known way for transmission in Step 46.

Referring now to FIG. 3, the Commercial Video & Skin Pre-Production Process will be described in detail. The flowchart of FIG. 3 illustrates the creation of the video and skin necessary to create a Commercial campaign on behalf of a client. In Step 60, the Commercial Video & Skin Pre-Production Process is initialized. The program proceeds to Step 61 where the size and scope of the client's campaign must be determined. The type of video (graphics or movie), the look of the skin and the size of the Opt-In E-Mail address list and the frequency of the mailing must all be determined. In Step 61 the client's objectives regarding the Commercial campaign are determined with respect to size and frequency of the campaign. The program proceeds from Step 61 to Steps 62 and 68 in parallel. In Step 62 a decision is taken regarding whether the client has the graphic for skin. If the answer is NO, then the program moves to Step 64 and the graphic is obtained. An appropriate graphic background for the skin must be selected, either from the client's stock or prepared by Franchisee or a third party. There are many sources, such as, graphics software, online clip art or samples available through Franchisee or a third party. If or when the answer to Step 62 is YES, the program advances to Step 63 where the decision is taken whether the client has text for skin. If the answer is NO, then text is written in Step 65. Text appropriate for the campaign must be created and approved by the client. Such items as company name, contact information, specials, discounts, etc. are used to “frame” the video. The text is placed on top of the graphic background and submitted to the client for approval in Step 66. When approval is received, the skin is stored for access by CVEG in Step 67, so that CVEG, by appropriate HTML code, can retrieve or fetch the skin for delivery via the Internet directly to the desktop (computer) of the recipient. The skin is saved in jpeg or .gif formats and stored in a web accessible location, either on Franchisor's intelligent video streaming server, the client's website or the client's server. The path to the skin is used for input to CVEG. Although the skin format in the drawing and as described is .jpeg, the skin file format does not necessarily have to be in JPEG format. It could also be GIF, PNG, BMP, and potentially any type of format that Microsoft Internet Explorer 5 and above support. The program now jumps at Step 77 to the Post Production process.

As noted above, the program in parallel determines in Step 68 whether the client wants a low cost production or a high cost production. Clients must decide whether they want a high cost movie video production to convey their message or a lower cost graphic slide show with music and voice. If the production is to be lower cost Franchisee works with the client to either secure graphics from an existing website, create them with commercial software or arrange for digital photography of appropriate images. If the client's answer to the decision in Step 68 is Low Cost, then the program proceeds to the decision of Step 69 that determines if the client can supply the graphics. If the answer to this decision is NO, the client cannot supply the graphics then the program steps to Step 71 where arrangements are made to obtain the photos, graphics from a website, etc., which are then put in digital format. In step 70 the client provides the graphics in digital format, and in Step 72 the client identifies the key points for script (text to overlay the graphics and put forth the client's message and other data. The program moves to Step 73 where it is determined what kind of music will accompany the commercial, i.e. jazzy, contemporary, classical, etc. Finally the program jumps to the Low Cost Production process at Step 78.

Summarizing the foregoing, once the graphics are selected they must be captured in digital format. An appropriate script for text and/or voice over must be written and approved by the client. Appropriate music must be selected to play in the background during the Commercial and supplied in an appropriate format. If commercial software is being used to produce the Commercial a selection of music is usually included in the program.

If the decision in Step 68 is High Cost, then the program proceeds to Step 74 where the client is referred to a suitable Production company to create the video. In Step 75 a request is made regarding the video compression format so that the format of the video should preferably be MPEG-1. However, one must bear in mind that there is a distinction between the two concepts of video compression format and the type of player software. The following are examples of player software: Microsoft Media Player;

Real Networks' Real Player; and Apple QuickTime. Some examples of media (audio/video) file formats are: MPEG (typical extensions: mpe, mpg, mpeg, mp3, mp4, etc.); Real media (RM,RA); QuickTime movie (extension: MOV); and Windows media format (extension: wma).

Some of these formats are proprietary which makes them only playable by their respective media players, such as, those of the Real Networks' RM and RA files, and Macromedia Flash whereas some like MPEG can be played by most including all the above players. CVEG and Franchisor's intelligent video streaming server are sensitive to the media player types. Specifically, CVEG recognizes the three above mentioned player programs, so that it computes the most suitable player, calculated based on bandwidth connectivity for the viewer so the intelligent server streams the most suitable video in case a certain type of player (out of the above possible installed one or many) happens to have been installed on the commercial recipient's computer. Therefore, it is quite possible and indeed valid to see the same video from different computers with different settings and bandwidth connectivity when streamed from intelligent server and delivered as a new Commercial Video E-Mail using CVEG.

Once the video compression format has been established in Step 75, the program moves to Step 76 where the production deadline is set, and when delivery is made, the program jumps to the Post Production in Step 79.

Summarizing the foregoing, in cases where a client desires a more expensive production for a Commercial, the client's existing video stock may be used or a professional production may be arranged through Franchisee or the client's chosen production company. Where professional video is produced, the final format should be provided as an .mpeg file or in any of the popular codecs, such as, MPEG (typical extensions: mpe, mpg, mpeg, mp3, mp4, etc.); Real media (RM,RA); QuickTime movie (extension: MOV); or Windows media format (extension: .asf, wma, .wmv). Completion of the video must be scheduled several days before the Commercial campaign start date. If the video file isn't compressed, the client must arrange to have the compression and format conversion done with any of the widely available compression software or Franchisee or Franchisor can do the file compression if necessary.

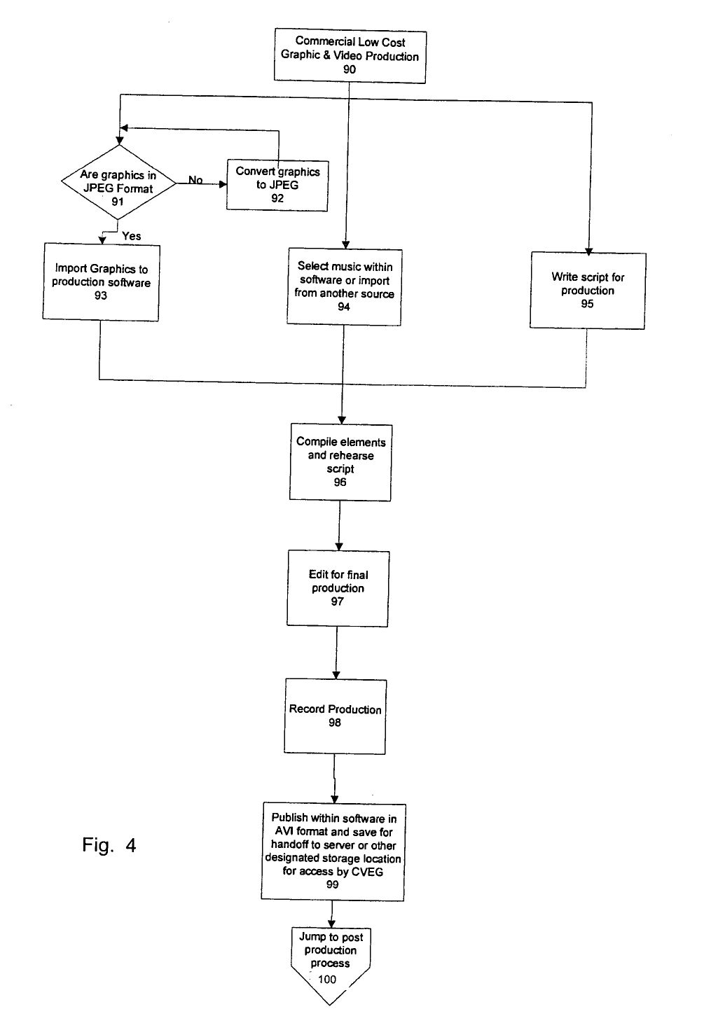

The Commercial Low Cost Graphic & Video Production is shown in FIG. 4. This flowchart expands on the steps followed by the Franchisee to create a graphics video production ready for linking to CVEG. The program is initialized in Step 90, and moves in parallel to Steps 91, 94 and 95. In Step 91 the decision is taken whether the graphics are in JPEG Format. If the answer to this decision is NO, then the program moves to Step 92 and the graphics are converted to JPEG, JPG, GIF, and the program returns to the main flow. When the answer to this decision in Step 91 is YES, the program advances to Step 93 where the graphics are imported to the production software. In Step 94 the music is selected within the software or is imported from another source, in either case it is ready to be imported to the production software. In Step 95 the script is written for production and readied for import into the production software. In Step 96, the three elements, graphics, music and script are compiled and the script is rehearsed. Final editing takes place in Step 97, and Production is recorded in Step 98, after which, in Step 99, the Production is published within software in AVI format and saved for handoff to the server or other designated storage location for access by CVEG. If the software is not in AVI format, but is in VHS, Digital Video, or Hi8 format, it needs to be converted to AVI. This can be done by either the Franchisee or the Franchisor. Finally, in Step 100 the program jumps to the Post Production Process. As previously noted, the CVEG generates the emails with HTML code so that after the email arrives at the desktop (computer) of the recipient, the HTML code goes and retrieves or fetches one or more of the following: a. video; b. image (graphic or skin); c. attachments; and d. links from one or more of the following locations: a. the intelligent video streaming server; b. another server(s) where it is stored; and c. website.

Summarizing the foregoing for the Low Cost Production, graphic images ready to be imported into commercial production software must be in jpeg format. As noted with reference to FIG. 3, the skin file format does not necessarily have to be in JPEG format. It could also be GIF, PNG, BMP, and potentially any type of format that Microsoft Internet Explorer 5 and above support. The client can select the number and type of graphic images to display during the video production, including appropriate text. Many videos run 30 seconds and five to six different graphics are displayed while intelligent server has the ability to host longer video clips such as Infomercials or even full motion picture. The graphic images are imported as jpegs to the commercial video production software. Most software will also include a library of graphics and text formats that can be used if necessary. Music to accompany the production can be imported or selected from the video production software library. Many clients will want to include voice over as the graphic images are displayed. The voice recording requires a script that can be synchronized with the graphics and recorded simultaneously. The graphics, text, music and script are arranged within the production software and can be repeatedly played in rehearsal mode as the script is read until all elements are synchronized. Necessary editing changes should be made and rehearsals repeated until the desired result is achieved. The final production is recorded in video format within the commercial production software. The commercial software will create a published version of the final production, usually in .avi format. Audio Video Interleaved (.avi) format is a bitmap-based format for the Windows platform. It is the most common format for PC based audio/video data and is easily compressible. The completed .avi file will be converted to .mpeg format and compressed during the process. After conversion/compression the video file will be stored on the novel intelligent video streaming server, a webpage or another server and the path recorded for input to CVEG.

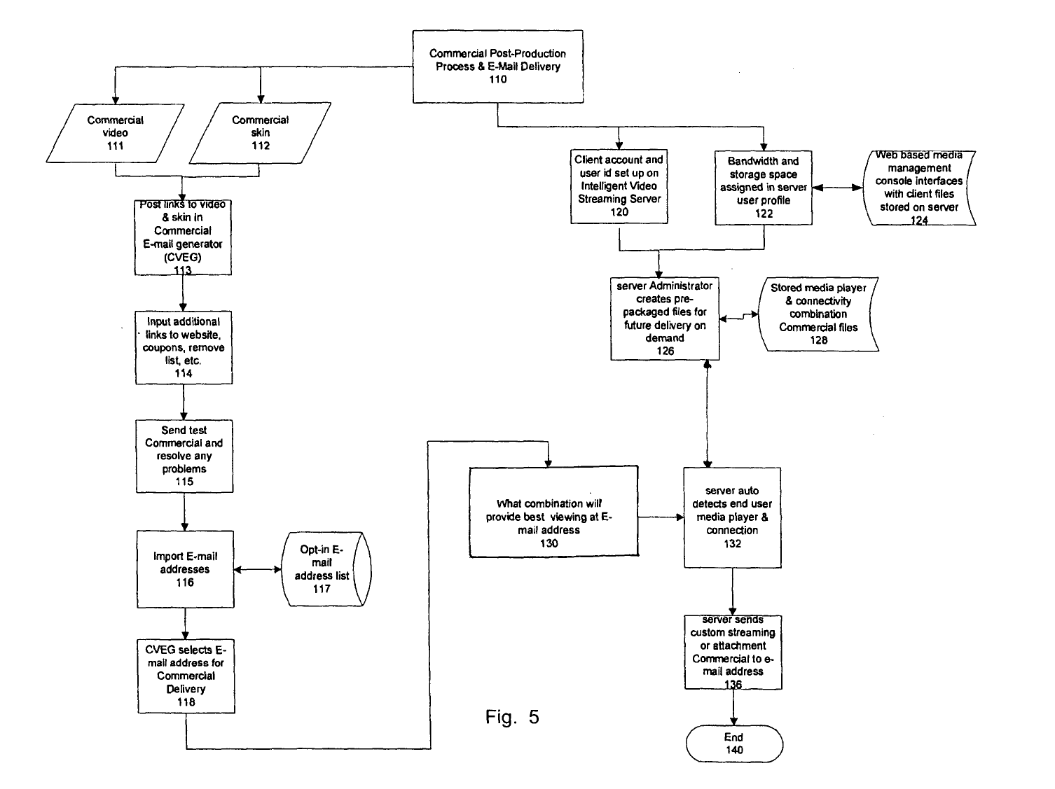

Shown in FIG. 5 is the Commercial Post-Production Process & E-Mail Delivery using CVEG and the novel Intelligent streaming Server. This flowchart illustrates the final steps to staging the Commercial elements for delivery to the Opt-In E-Mail client list using the intelligent video services provided by the novel intelligent server. The Commercial Video E-Mail Generator (CVEG) has been designed to assemble the components of video based Commercials and send them as streaming video or as attachments.

The Commercial Post Production Process & E-Mail delivery is initialized in Step 110. In parallel the program moves to Steps 111,112, 120 and 122. In Step 111, the Commercial video, and in Step 112, the Commercial skin are each accessed. This aspect of the program can be carried out by the Franchisee or the Franchisor. The program moves to Step 113 where links are posted to video and skin in the Commercial Video E-Mail Generator (CVEG), which as already noted is under the exclusive control of the Franchisor. In Step 114, additional links are input to the CVEG regarding website, such as coupons, remove list, etc. In Step 115, the Commercial is tested to resolve any problems that are detected and corrected. Step 115 is done by the Franchisor or alternatively, by the Franchisee under the control of the Franchisor. In Step 116, the E-Mail addresses of recipients are imported from Step 117 the Opt-in E-mail address list storage, preferably permission based. In Step 118, the CVEG selects the E-mail address for Commercial delivery, and the program proceeds to Step 130 where a determination is made regarding what is the best viewing for the recipient at the E-mail address.

In the meantime, under the exclusive control of the Franchisor, the administrative functions are being performed. In Step 120, an administrator appointed by the Franchisor sets up client accounts and user ids on the Intelligent Video Streaming Server. Also, in Step 122 an administrator appointed by the Franchisor allocates bandwidth and storage space in the server for each user profile. In Step 124 a web-based media management console interfaces with client files stored on the server; the console is accessible by the client, Franchisee and Franchisor. From Steps 120 and 122, the program advances to Step 126 where the server Administrator creates prepackaged files for future delivery on demand, interacting in Step 128 with a suitable storage in the server for storing media player and connectivity combinations for the Commercial files. This will be explained in greater detail in the following. As will be appreciated the protocol of the inventive system comprises each client's disk space, bandwidth, and media format for display. Pricing is predicated on disk space and bandwidth.

From Step 130, the intelligent video streaming server raises an issue about the combination that will provide the best viewing at the recipient E-mail address, and the program moves to Step 132 where the IVSS (intelligent video streaming server) auto detects, based on the compressed E-mail, the media player of the end user (recipient) and the connection to the end user that will give the best result for viewing, and on that basis proceeds to selects that combination from Steps 126 and 128. The program now advances to Step 136 where the server sends custom streaming or attachment Commercial to the recipient's e-mail address. The program ends at Step 140.

Summarizing the above, access to CVEG requires a valid user name and password. Access to Intelligent Video Streaming Server also requires proper user id and password assigned by administrator of Franchisor. Next, valid ISP POP3 and SMTP server addresses must be input followed by the web links to the storage locations for the previously created skin and video. Up to five different labels and their corresponding links can be input. Such labels as “For more information visit our website,” “To be Removed” or “To Print a Coupon” can be created to direct recipient actions upon viewing the Commercial. Once all the necessary links are defined in CVEG, a message is sent to known recipients to test for errors. Ideally a test should send each of the various combinations of media player and bandwidth. Any problems detected should be resolved and additional test messages sent until the Commercial plays correctly at each E-Mail address. Once the Commercial skin and video are ready, the E-Mail address list can be manually input or imported to CVEG. CVEG is loaded and ready to deliver a Commercial to each name on the Opt-In E-Mail list. However, the process cannot proceed without preparation on the intelligent video streaming server. Each client of the Franchisee who wishes to be a subscriber to the Intelligent Video Streaming Server technology will have a configuration built for their account. Each subscriber to the Intelligent Video Streaming Server will purchase a quantity of storage space and bandwidth based on a forecast of its Commercial campaign requirements. The appropriate specifications will be detailed in their user profile. The subscriber can access its Intelligent Video Streaming Server folder and its data through a web based media management console. Each Intelligent Video Streaming Server client will have an assigned Franchisor administrator to assist in data management. When the Commercial video is converted to an .mpeg file, a copy will be sent to Intelligent Video Streaming Server using any common FTP software. The administrator for that account will convert the client's media content into six separate files containing a combination of a high band and a low band version of three of the most common codecs, Real Media, Apple Quick Time and Microsoft Media Player. As a Commercial is sent to each E-Mail address from CVEG the Intelligent Video Streaming Server intelligent software detects the combination of bandwidth and media player on the recipient's desktop and selects the appropriate file from the client's inventory to be played instantly when the E-Mail is opened.

The novel server of the present invention is a video streaming server aimed at providing streaming service providers with an easy to use tool for creating and managing accounts for customers as well as providing the customers with a control panel for uploading and managing their video clips. Also, as noted, there is a server administrator. The server administrator is the individual responsible for creating and managing customer accounts. Clients or customers are companies or individuals that acquire a server account from the administrator and use the server as a host for their media clips.

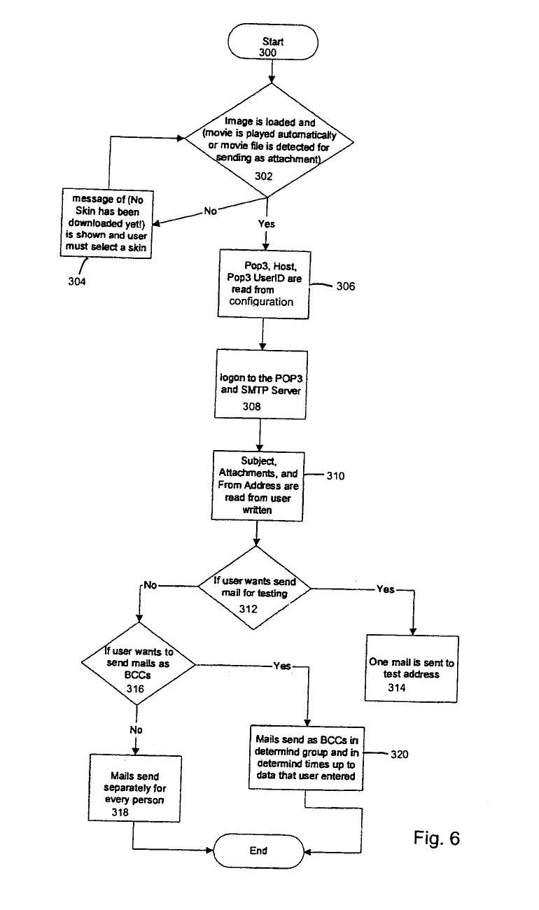

Referring now to FIG. 6, a flowchart is shown illustrating the program for the CVEG in sending out emails. As shown, the program is initialized in Step 300 and proceeds to a decision in step 302 regarding the image. In Step 302 the image is loaded and movie is played automatically or movie file is detected for sending as attachment. If the message of no skin has been downloaded yet is shown, user must select skin in Step 304 and the program goes back to Step 302. If all is in order, the program advances to Step 306 where the POP3, Host POP3 and User ID are read from the configuration. In Step 308, logon on to the POP3 and SMTP server takes place. In Step 310 subject, attachments, and address is read from client supplied email recipient list. In Step 312 a decision is taken whether the client wants to send email for testing. If YES, then in Step 314, one or more emails are sent to test address, usually the client's address. When satisfied, or when the client does not want to continue testing or do any testing, and the answer to the decision in Step 312 is NO, then the program moves to the decision in Step 316, whether the client wants to send mails as BCCs. If the answer is NO, then in Step 318, individual emails are sent separately for every recipient on the address list and the program ends. If the answer is YES, then the program moves to Step 320 and the emails are sent as BCCs in predetermined batches and at predetermined times until all emails have been sent to the recipients on the address list provided by client, and then, the program ends.

There follows a brief description of some of the more salient aspects of the novel server to better understand the software and the functionality. Before beginning with the details of administering the server, it is desirable to clarify the meaning of certain terms used:

The Admin Site means the web-based interface used accounts for creating and managing server customers.

Customer means the company or individual that has acquired a server account and can upload and manage their own media clips on the server. Media clips can be in form of video, animation, Flash, audio, image and animated GIF.

The Customer Site means the web-based interface used by customers as a control panel for managing their clips.

The server Admin a.k.a. the Administrator means the individual(s) responsible and authorized to use the Admin Site to create and manage customer accounts. This person has the password for the Windows Administrator account of the computer on which the server software is installed.

Users mean the visitors to or recipients of customer's streamed clips. Therefore a user can be any Internet user and does not need any special server account.

An example of specific system software and hardware requirements are System Requirements

Server Side:

Microsoft Windows 2000 Server/Advanced Server (SP2 or above)

Microsoft Internet Information Server (IIS) 5.0

Microsoft Data Access components (version 2.6 or later)

Enough Hard Disk Space for hosting customers' media clip files. The disk partition(s) containing the clip files must be of NTFS type. For more security, it is recommended to use a system having all disk partitions of NTSF type.

Recommended CPU and RAM configuration for Windows 2000 (Advanced) Server.

Whereas the foregoing is based on a Windows 2000 server, it will be appreciated that upgrading to a Windows XP server can be effected or to any comparable or superior server system as it becomes available.

Client Side:

Any JavaScript enabled browser. Microsoft Internet Explorer 5 or above recommended.

The term client here is meant to refer to the computer the customer and the server Administrator use to connect to the Customer Site and the Admin Site, respectively, as well as the computer a user (or recipient) downloads a media clip.

To install and configure the novel server, there will be the conventional installation package containing a set-up program called Setup.Exe. This is the executable file that should be run in order for the server software to be installed.

Once executed, Setup.Exe, would take one through a series of steps asking about the following items of

Your name as well as the name of your company

The path on the server's hard disk where you want server software to be installed.

The name of the folder created under the Programs group in your Windows Start menu. By default this is set to NS-IV8. However other names as may be registered by world wide web may be used for hosting the intelligent video streaming application software.

Once these items are given to the installation program, it will start copying files and will perform preliminary configuration settings on the server. At the end of the installation process, Administrator will be asked whether he/she wants the configuration program to be launched. If Administrator chooses not to run the configuration program at that time one can always have access to it through the folder under the Programs icon in the Start menu. It is called IV8_Configurator. Exe.

The second phase of setting up the novel software on a server is to configure the installed product using the above mentioned configuration program. The configuration phase involves performing the following tasks:

Creating a Windows user group named customers.domanname.com (Example: customers.nsiv8.com; customers.nsiv8.net). As its name implies, all customer users will join this group.

Adding the Windows Administrator user to the Customers (customers.nsiv8) group.

Granting certain rights to the Customers group as well as to two Windows users called IUSR_MachineName and where MachineName is the computer name designated to that server in Windows. These users are used by IIS and because of the software security model they need to be granted certain additional rights.

Creating and configuring the Customer Site in IIS.

Creating and configuring the Admin Site in IIS.

Configuration of the Customer and Admin sites among other things involves assigning IP address and/or Internet DNS host names, as well as, TCP ports to those sites. These are the parameters the configuration software will ask administrator when he/she first executes it. By default, the Customer Site hostname is set to www.domainname.extension (e.g. www.nsiv8.com) and that of Administration Site to admin.domainname.extension (e.g. admin.nsiv8.com). Their respective TCP ports are by default set to specified ports. So for example the Administration Site may be accessed via the URL http://admin.nsiv8.com:8091. It is important to note that the configuration software does not automatically register the hostname to any DNS servers; so it is assumed that whatever hostnames chosen for these sites are already registered in Internet DNS servers.

If any one of the above tasks cannot be successfully performed a cross sign will appear next to it signifying a failed task. Successfully finished steps will be marked with a check sign. After the configuration software performs all the above tasks successfully the server must be restarted once in order that all security settings take effect.

The first thing to do in order to test whether intelligent video streaming server (IV8) software has been installed and configured correctly is to connect to both the Customer and the Admin sites. By default these sites should be accessible through the addresses www.nsiv8.com and http://admin.nsiv8.com:8091 unless some other host name and TCP port number has been assigned to them while configuring. If they do in fact appear in the browser, this is an indication that the software has been installed and configured correctly.

Use of the server Admin Site involves the following. In order to logon to the system one will have to have the password for the system administrator account. That is normally set as the same as one's Windows Administrator account. Technically, in order for the Admin Site to be able to perform administrative tasks such as creating users and IIS web sites, it is configured so that one should log on to it as a user, that is, a member of the Windows Administrators security group. Only the Windows Administrator and the user, but not the whole group, can log on to the Admin Site.

When successfully logged on, the screen shows a list of the clients or customers. The homepage, similar to other pages in the Administrator (Admin) Site, consists of three sections, video, audio and images. A header at the top of the page bearing the Franchisor's logo, the left side menu panel which contains links for performing different tasks on and related to media streaming site management and the main body. The contents of the menu panel, as well as, the main body change depending on where in the Admin Site one is.

In the case of the homepage, the menu panel contains links to all the tasks the administrator can perform including creating, deleting and modifying customer accounts and site settings. The main body of the homepage of course, contains a selectable list of clients or customers showing the user id, description, and the amount of disk quota each client or customer is using and whether or not their account is disabled. An entry within the list is selected (by highlighting) and is the one the commands in the left menu panel are applied to. Any of the customers can be selected by just clicking on them.

To create a New Customer (Client) Account on the software and server, one clicks on Add Customer in the left menu panel. The software will then create the account by asking a number of questions in two steps. In the first step, one is asked to pick a user name, password, as well as, a description for the customer's site. In the second step, Admin will adjust some parameters for the customer's site and preferences. Here by customer's site is meant the site that will be created for the customer so that specific customer can upload his/her media clips. It is basically created automatically by software with certain parameters set to the values specified at this second step of account creation.

The first thing Administrator needs to identify is how a customer site can be reached from the Internet; i.e., its address. The address comprises of three elements: an IP address, a host name such as www.mysite.com and a TCP port. The address assigned to a site, must be unique among the sites created on the server that the IV8 software is installed on. This includes the Admin Site and the Customer Site that are treated as web sites themselves. The IP address, as well as, the hostname is optional. Administrator can just leave the entry blank but a TCP port must be specified. If Administrator tries to assign an address that is in conflict with another site, the software will issue an error message and will ask Administrator to enter new values for the address elements. However, using a novel naming convention ischemia, such conflicts can be resolved automatically and specific TCP ports may be used for several customers at the same time. After Administrator decides on the address to be assigned to the new site, a home directory for that site must be selected. It cannot be a previously existing folder named on the server. Any name for the folder and any of the NTFS partitions available on the server machine can be selected, but it is recommended that Administrator keeps customers' home directories in each other's vicinity. For example, the home directories can all exist on drive D: of the server all within a folder called iv8home. This way the path to a customer's home directory would be something like D:\Iv8Home\customer1. Administrator does not need to create these folders manually. Once they are specified, the path, the software will create all the necessary folders along the path until it reaches the destination folder (customer1 in the above example).

There are three more items of information to be specified in order for a customer site to be created, namely, (1) allowed file extensions for upload, (2) the amount of disk space (quota) in megabytes assigned to that customer account and (3) the maximum bandwidth, expressed in kilobytes per second, the customer's site is allowed to use while serving users. All three of these parameters are filled with default values, so if one is not sure what to enter into them, the default values are left intact. Once specified, the customer can only upload files with the allowed extensions.

The disk quota (as well as all the other settings mentioned above) can later be changed but cannot be decreased below the currently used amount. That is, if the user has currently uploaded files with a total size of 5 megabytes, disk quota cannot be reduced to a value less than 5.

Administrator assigns the bandwidth use to each customer, for example, assigning to a customer a maximum bandwidth of say 10 kilobytes per second. A 10 kilobyte-per-second bandwidth limit means that intelligent server will continue to respond to user requests for downloading (and streaming) files until the maximum used bandwidth exceeds 10 kilobytes per second. After that the server will start queuing new user requests until the old ones are served. Administrator can also choose to waive the bandwidth limit by selecting a checkbox provided labeled Unlimited.

The procedure, by which a video e-mail is streamed or a web browser watches media file, is selected by the intelligent video streaming server logic and algorithm auto-player is now described. As noted above, media files are categorized by their preferred media player as determined by the client or customer while uploading the file, their associated network connection also as determined by the customer, and their format as determined by their file extension, e.g. MPG, WMA, etc. For example, an MPEG file uploaded for being played whenever the recipient or user (visitor) has a modem connection and associated with the Windows Media Player could be called mod_mp_myvideo.mpg.

At the time the visitor wishes to watch/listen to a certain media (video/audio clip) that is hosted by the Intelligent Video Streaming Server (IVSS)(IV8 software), the intelligent auto-player selects the file that best suits the visitor's network and player configuration. There are times that only one file may qualify for users setting, however, usually the browser (of the recipient) may have number of qualified media players installed in his/her computer settings. Accordingly, the present invention includes an algorithm that finds the optimum choice among the qualified media players, media formats, desktop settings, and bandwidth connection.

In the description that follows, a “modem” connection means any network connection with a speed of less than or equal to 4 Kilobytes per second and a LAN connection means any network connection with a speed of more than 4 Kilobytes per second. Therefore, the terms “modem” and “LAN”, as used herein, do not necessarily reflect the kind of networking technology and apparatus used by a recipient or user.

For the purpose of further describing the invention, suppose certain video formats, such as, the following files are uploaded:

mod_mp_mybideo.wmv

lan_rp_myvideo. rm

mod_qt_myvideo.mov

mod_qt_myvideo.mpg

If the user has a LAN connection and tries to play the clip using IVSS's auto-player, the only possible media file would be lan_rp_myvideo.rm provided that the user actually has a RealPlayer installed on his/her machine, otherwise IVSS would try to play ANY file that could be played by the available players on user's computer, regardless of the file's or the user's network connection configuration.

However, when a browser with a MODEM connection accesses, receives or reaches the intelligent streaming server (IVSS), the auto-player, will have three possible choices, namely those that start with mod_. Of these three, two are associated with the QuickTime player and one is associated with the Windows Media Player. Assuming the user has both players installed on his/her machine; all three will qualify for being the choice player. Then the algorithm of the present invention must make an intelligent decision.

First IVSS's algorithm identifies the right media files for users viewing experience and or request. Then, it scores each possible media file with certain level of factors. The file that earns the highest score will be the one that is played. With such a measured certainty factor, a rule-based engine computes and streams the highest rated media file format. Scores and decision criteria are made of two components:

Format conformity score (a value in the range 0-10)

Connection speed score (a value in the range 0-10)

The format conformity score reflects how much a file's format (extension) goes with its customer-specified associated player. For example, a WMV file (a Microsoft proprietary format) best fits the Windows Media Player for compliance and association reasons. Now, suppose this file is associated with the RealPlayer. This reduces its format conformity score to 8. A WMV file associated with the Windows Media Player scores 10 in IVSS software whereas it will score 8 if it is assigned to the RealPlayer. The less compatible the format is with the associated player, the less its conformity score will be. An RM file associated with the Windows Media Player scores 0 because the Windows Media Player cannot play RM files. The conformity score is hard coded into IVSS in the form of a look-up table. Table 1 shows a specific example of a format connectivity score table that can be hard coded into IVSS.

TABLE 1
Conformity Score Lookup table

Associated Player

| | Windows | Real- | Quick- | |
|---|---|---|---|---|
| Extensions | Media Player | Player | Time | Flash |
| ra, ram, rm | 0.0 | 10.0 | 0 | 0.0 |
| rmm, rmj rmd | | | | |
| mpeg, mpg, | 10.0 | 9.0 | 5.0 | 0.0 |
| mpe, mpa | | | | |
| mp2 | | | | |
| Wmv, wma, | 10.0 | 8.0 | 0.0 | 0.0 |
| asf | | | | |
| Swf | 3.0 | 2.0 | 5.0 | 10.0 |
| avi, wav, au, | 10.0 | 8.0 | 0.0 | 0.0 |
| midi, mid | | | | |
| rmi, ,m1v, | 10.0 | 0.0 | 0.0 | 0.0 |
| snd, | | | | |
| aif | | | | |
| mov | 4.0 | 0.0 | 10.0 | 0.0 |

The connection speed score reflects how much the user's connection speed goes with the file's size. This score is calculated based on the assumption that the larger a file is, the higher its quality will be. The formula according to which the raw speed score is calculated is as follows:

$$RawSpeedScore = {( \frac{FileSize}{KBPS} )}^{β}$$

The file size is expressed in Kilobytes, KBPS is the connection speed expressed in Kilobytes per seconds and β is real number between −1 and 1 the bias factor.

A bias factor of 1 means that the score strictly favors larger (high quality) files. A bias factor of −1 means that the score strictly favors smaller (low quality, faster downloading) files. A bias factor of 0 means that the connection speed score will not be taken into account (the system does not discriminate among files based on their size). The bias factor is determined individually for each clip by the customer. This is indicated in the IVSS user interface as a sliding track bar labeled “Performance”. The Performance Bar is decided by the host customer. It is founded on two important foundations, quality versus speed. When the track is slid towards the side indicated as “Optimize for quality”, the bias factor is moved closer to 1 and when it is slid towards “optimize for speed” the bias factor is moved closer to −1. When the track is in middle position, the bias factor is zero.

The raw speed scores are then normalized into values in the range 0-10 by dividing them all by the highest speed score among the list of media file formats. Therefore, the speed score is a relative score and a file may be scored differently when appearing in different candidate lists.

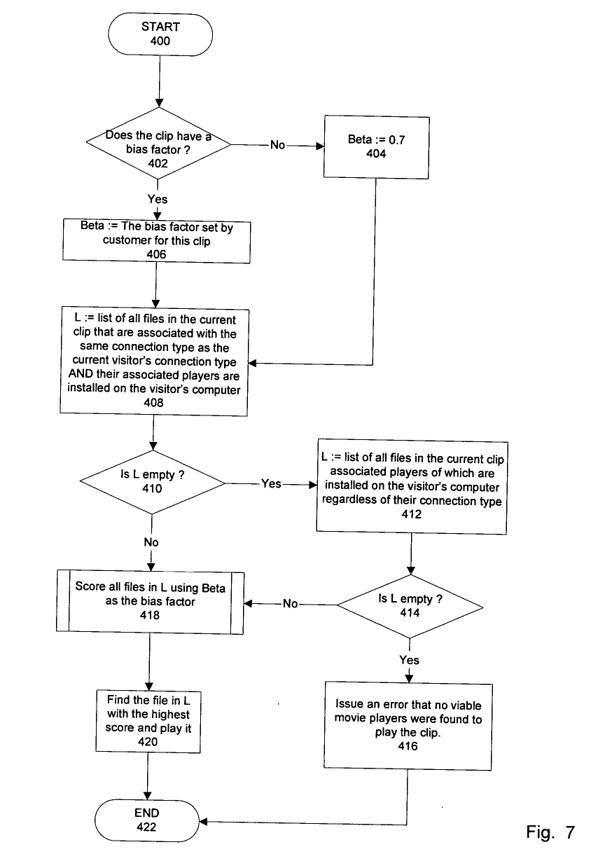

The overall procedure describing the way a media file is picked by IVSS's auto-selection mechanism for playing is shown in FIG. 7 in the form of a flowchart. As can be seen in the flowchart, the program is initialized in Step 400, and proceeds to a decision in Step 402 concerning does the clip have a bias factor?. If the answer is NO, the program proceeds to Step 404 where the Beta is set to 0.7 and the program proceeds to Step 408. If the answer is YES, the program moves to Step 406, and Beta is set to a bias factor of the customer's choosing, and the program proceeds to Step 408. In Step 408, scoring is performed according to the formulae explained in the previous section, that is, a list L is determined based on all files in the current clip that are associated with the same connection type as the current visitor's connection type AND their associated players as installed on the visitor's computer. Next the program moves to Step 410 where a decision is make concerning whether L is empty or not. If the answer is NO, then the program proceeds to Step 418. If YES, the program proceeds to Step 412 where a list L is compiled of all files in the current clip associated players of which are installed on the visitor's computer regardless of their connection type, and the program proceeds to a decision in Step 414 whether L is empty. If YES, the program moves to Step 416 and issues an error that no viable movie players were found to play the clip, and the program ends in Step 422. If the answer to the decision in Step 414 is NO, the program proceeds to Step 418. In Step 418 the list L of files are scored using Beta as the bias factor, and the program moves to Step 420 where the file in list L with the highest score is found and played, and the program ends at Step 422.

So the ultimate recipient of video email or the web browser of the host Customer will be able to watch the right video format without any decisions on their part as hosted on many sites that stream video with various settings (e.g. 56K, 100K, 300K, Windows, Real Media).

The present invention can be produced in hardware or software, or in a combination of hardware and software, and these implementations would be known to one of ordinary skill in the art based on the disclosure herein. The system, or method, according to the inventive principles as disclosed in connection with the preferred embodiments, may be produced in a single computer system having separate elements or means for performing the individual functions or steps described or claimed or one or more elements or means combining the performance of any of the functions or steps disclosed or claimed, or may be arranged in a distributed computer system, interconnected by any suitable means as a local area network (LAN) or widely distributed network (WAN) over a telecommunications system (such as the Internet) as would be known to a person of ordinary skill in the art.

Computer Nodes and Group Members

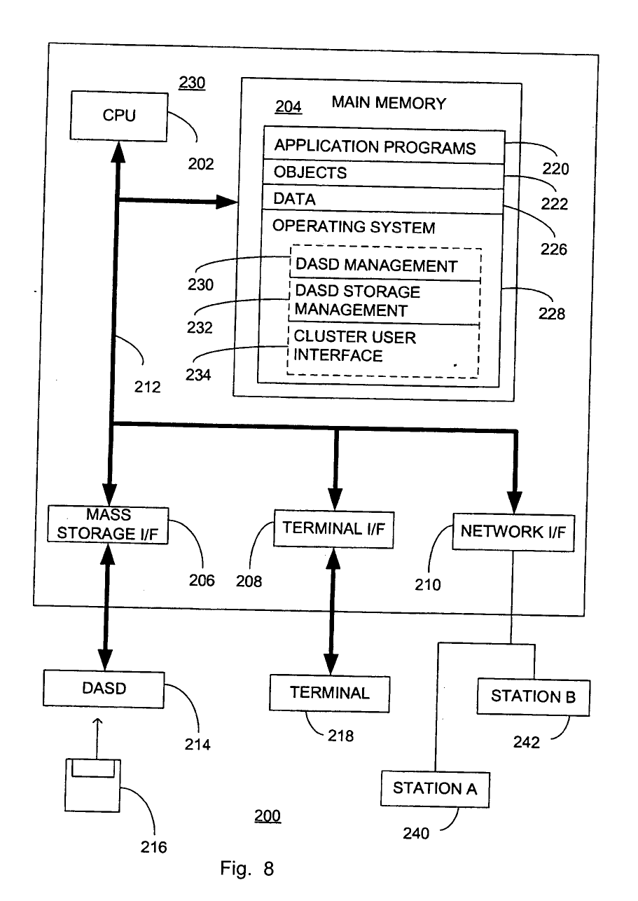

FIG. 8 shows a block diagram depicting a group member 200, which is a computer system in an exemplary embodiment, of a group of computers usable in the system or apparatus of the present invention. The group member 200 of the exemplary embodiment is an IBM eServer iSeries server system. Any suitably configured processing system is similarly able to be used by embodiments of the present invention. The computer system 200 has a processor 202 that is connected to a main memory 204, mass storage interface 206, terminal interface 208 and network interface 210. The system components are interconnected by a system bus 212. Mass storage interface 206 is used to connect mass storage devices, such as DASD device 214, to the computer system 200. One specific type of DASD device is a floppy disk drive, which may be used to store data to and read data from a floppy diskette 216.

Main Memory 204 contains application programs 220, objects 222, data 226 and an operating system image 228. Although illustrated as concurrently resident in main memory 204, it is clear that the applications programs 220, objects 222, data 226 and operating system 228 are not required to be completely resident in the main memory 204 at all times or even at the same time. Computer system 200 utilizes conventional virtual addressing mechanisms to allow programs to behave as if they have access to a large, single storage entity, referred to herein as a computer system memory, instead of access to multiple, smaller storage entities such as main memory 204 and DASD device 214. Note that the term “computer system memory” is used herein to generically refer to the entire virtual memory of computer system 200.

Operating system 228 is a suitable multitasking operating system such as the IBM OS/400 operating system. Embodiments of the present invention are able to use any other suitable operating system. Operating system 228 includes a DASD management user interface program 230, a DASD storage management program 232 and a group user interface program 234. Embodiments of the present invention utilize architectures, such as an object oriented framework mechanism, that allows instructions of the components of operating system 228 to be executed on any processor within computer 200.

Although only one CPU 202 is illustrated for computer 202, computer systems with multiple CPUs can be used equally effectively. Embodiments of the present invention incorporate interfaces that each include separate, fully programmed microprocessors that are used to off-load processing from the CPU 202. Terminal interface 208 is used to directly connect one or more terminals 218 to computer system 200. These terminals 218, which are able to be non-intelligent or fully programmable workstations, are used to allow system administrators and users to communicate with computer system 200.

Network interface 210 is used to connect other computer systems or group members, e.g., Station A 240 and Station B 242, to computer system 200. The present invention works with any data communications connections including present day analog and/or digital techniques or via a future networking mechanism.

Although the exemplary embodiments of the present invention are described in the context of a fully functional computer system, those skilled in the art will appreciate that embodiments are capable of being distributed as a program product via floppy disk, e.g. floppy disk 216, CD ROM, or other form of recordable media, or via any type of electronic transmission mechanism.

Embodiments of the present invention include an operating system 228 that includes a DASD management user interface program 230 that performs functions related to configuration, operation and other management functions, including functions for selecting one or more DASDs for an auxiliary storage pool (ASP). An ASP is defined as a set of disk units, and an independent auxiliary storage pool (IASP) is a set of disk units independent of a system. An IASP can be switched between systems, if its disk units are switchable and follow configuration and placement rules. The DASD management user interface program 230 is able to communicate with DASD storage management (DSM) program 232, which is a component of operating system 228 that provides internal support for managing disk units.

Non-Limiting Software and Hardware Examples

Embodiments of the invention can be implemented as a program product for use with a computer system such as, for example, a cluster computing environment as described herein. The program(s) of the program product defines functions of the embodiments (including the methods described herein) and can be contained on a variety of signal-bearing medium. Illustrative signal-bearing medium include, but are not limited to: (i) information permanently stored on non-writable storage medium (e.g., read-only memory devices within a computer such as CD-ROM disk readable by a CD-ROM drive); (ii) alterable information stored on writable storage medium (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the present invention, whether implemented as part of an operating system or a specific application, component, program, module, object or sequence of instructions may be referred to herein as a “program.” The computer program typically is comprised of a multitude of instructions that will be translated by the native computer into a machine-readable format and hence executable instructions. Also, programs are comprised of variables and data structures that either reside locally to the program or are found in memory or on storage devices. In addition, various programs described herein may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

It is also clear that given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.) It should be appreciated that the invention is not limited to the specific organization and allocation or program functionality described herein.

The present invention can be realized in hardware, software, or a combination of hardware and software. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

Each computer system may include, inter alia, one or more computers and at least a signal-bearing medium allowing a computer to read data, instructions, messages or message packets, and other signal bearing information from the signal bearing medium. The signal-bearing medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the signal bearing medium may comprise signal bearing information in a transitory state medium such as a network link and/or a network interface, including a wired network or a wireless network, that allow a computer to read such signal bearing information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the spirit, scope and contemplation of the invention as defined in the appended claims.

1. A method for generating a video email comprising the steps of:
i. providing a video for display on a computer screen;
ii. providing a skin image for display on a computer screen;
iii. correlating the video and the skin image positions in a pre-selected matrix to display on a computer screen;
iv. establishing a sender's email address;
v. establishing a subject heading for broadcasting a video email;
vi. creating a link to the skin image and a link to the video for integrated access and uploading; and
vii. creating the ability to fetch and display the skin image and the video for display on a computer screen of a recipient in the pre-selected matrix.

2. The method of claim 1 wherein the video is stored at one of a streaming server, designated IP Address, and a web site.

3. The method of claim 1 wherein the video is a file stored in a streaming server.

4. The method of claim 1 wherein the skin image is stored at one of a streaming server, designated IP Address, and a web site.

5. The method of claim 1 wherein the skin image is an animated file.

6. The method of claim 1 wherein the video is stored at one of a streaming server, designated IP Address, and a web site for integrated access and uploading.

7. The method of claim 1 wherein the video and the skin image are stored at one of a streaming server, designated IP Address, and a web site for integrated access and uploading.

8. The method of claim 1 wherein a reply address is created as an alternate email address for correspondence.

9. The method of claim 1 wherein an action label is created in form of text or image connecting to at least one of a link, email address, web page, and IP address.

10. A method for placement of a skin image comprising the steps of:
i. creating a link to a skin image file to establish an input defining the location of the skin image file on a computer screen;
ii. creating a link to one of an intelligent video streaming server, IP specific address and web site at which the skin image file is stored and located for integrated access and uploading of a skin image file to a computer screen of a recipient;
iii. establishing the ability to fetch and display the stored skin image file from its location; and
iv. creating the capability of changing the size of the fetched skin image on a computer screen to fit a user's need.

11. A method for placement of a skin image according to claim 10 wherein the skin image is stored on an intelligent video streaming server.

12. A method for placement of a skin image according to claim 10 includes the further step of creating the capability of scrolling the skin image on a computer screen.

13. A method for placement of a skin image according to claim 10 wherein the change in size includes at least one of changing the width and length.

14. A method for placement of a skin image according to claim 10 wherein the change of size is manifest by an expandable rectangular box covering a specific area or all skin image surface for hyperlink to a URL address (Web site address).

15. A method for placement of a skin image according to claim 10 wherein the skin image is created in a plurality of skin image files.

16. A method for placement of a skin image according to claim 15 wherein a plurality of links are established to IP specific addresses or web sites for entering the location of the skin image files.

17. A method for placement of a video clip comprising the steps of:
i. creating an email to which is associated a video clip and an image file, ii. sending the email from an email sender to an email recipient iii. enabling the image file to be displayed and the video clip to be played automatically when the email arrives in the recipient's mailbox.

18. A method for placement of a video clip according to claim 17 wherein the video clip is sent as an attachment.

19. A method for placement of a video clip according to claim 17 wherein the video clip plays automatically within the skin image file in a position defined on a computer screen by the email sender.

20. A method for placement of a video clip according to claim 17 wherein the video clip and skin image are corrected to a pre-selected screen format identifying desired location for video playing on the email.

21. A method for placement of a video clip according to claim 17 wherein

22. A method for placement of a video clip according to claim 17 wherein the video clip plays automatically when the email recipient clicks on a designated area of the skin image file as defined by the email sender.

23. A method for placement of a video clip according to claim 17 including the further step of creating a method for video popping up on a computer screen and playing automatically.

24. A method for placement of a video clip according to claim 17 including the further step of setting an alternate method of video playing on a pop up screen in the event video email recipient's computer and desktop settings prohibit automatic playing of the video.

25. A method for placement of a video clip according to claim 17 including the further step of the video playing automatically when email recipient clicks on a specified area of the skin image as specified by video email sender by popping up on a computer screen and playing automatically.

26. A method for placement of a video clip according to claim 17 including the further step of establishing authorized authentication, direct connection, and video access through an intelligent video streaming server for uploading of video file(s) to the intelligent video streaming server.

27. A method for placement of a video clip according to claim 26 including the further step of providing an automated link and its automatic paste entry of video streaming code from the intelligent video streaming server into the video clip input field.

28. A method for placement of a video clip according to claim 17 including the further step of establishing an input link to at least one of an IP specific address, a streaming server and a web site where video file is located for entering designated location of video file(s).

29. A method for placement of a video clip according to claim 17 including the further step of creating the ability for input link to video files based on formats available from Microsoft Media Player Format, Real Network's Real One Formats, Apple Quick Time Formats, Motion Picture Expert Group (MPEG) Formats, and Macromedia Flash Formats.

30. A method for placement of a video clip according to claim 17 including the further step of establishing variable video formats for broadband and modem connection and broadcasting streamed from at least one of an intelligent video streaming server, a designated IP Address, a video streaming server and a web site.

31. A method for placement of a video clip according to claim 17 including the further step of providing capabilities for secured and firewall sites to view video.

32. A method for placement of a video clip according to claim 17 including the further step of establishing exception rules for unified display of video email for public (POP) email account sites including Yahoo, Hotmail, AOL, MSN, and other public email sites limited to Internet browser access only.

33. A method for placement of a video clip according to claim 17 including the further step of creating provisions for video access on a computer screen when a video email recipient's program does not support scripted programming language displaying video on a computer screen.

34. A method for placement of a video clip according to claim 17 including the further step of showing hyperlinks to designated a video location where no known video format or player is installed on video email recipient's computer disk or is prohibited by desktop settings.

35. A method for placement of a video clip according to claim 17 including the further step of creating an input text field of instruction inputted by video email sender for instructing email recipient accessing video in the event there were no known video formats or video player installed on recipient computer disk and desktop settings.

36. A method for placement of a video clip according to claim 17 including the further step of creating an input image field of instruction inputted by video email sender for instructing email recipient accessing video in the event there were no known video formats or video player installed on recipient computer disk and desktop settings.

37. A method for placement of a video clip according to claim 17 including the further steps of sending and receiving attachment files of any size;
locating an attachment file in any disk storage media format including network systems; and storing attachments as a list for immediate or future adding or deletion when sending a video email.

38. The method of importing email addresses comprising the steps of establishing a storage; creating a user manual input of email accounts; establishing a test email account for testing and viewing on a computer screen; importing email accounts from one of Plain Text, Microsoft Excel, Microsoft Access, Open Data Base Compliance (OBBC) data sources, Microsoft Outlook and Outlook Express, Microsoft Word, and other formats supporting ASCII files with and without delimiters for separating fields of information, such as, name, address, email from one another; customizing step-by-step Wizard for Plain Text, ASCII, Excel, Access, and ODBC data source (automated program) helping import of such data becoming simple and easy; exporting such email list (once imported) as Plain Text and ASCII file format for future ease of use and downloading into the storage for use in a video emailing system.

39. A method for creating a video email code comprising the steps of managing and generating computer codes in various formats including limited to HTML, JavaScript, XML, and other machine usable codes for use on display on computer screen; generating automatic code for ease of use and transmission (broadcasting) of video email to recipient(s); establishing the capability to add, edit, modify, copying, printing, deleting and making changes to automatically created computer generated video email code for additional customization and conditional improvement as video email sender deems necessary; saving such code in both automated and custom version form in at least one of HTML, XML and other machine generated computer language code formats for future use and archival; Importing such code in formats including HTML, XML and other computer generated code for future use and broadcasting on a computer screen.

40. A method for sending a video email comprising the steps of sending one video email per recipient; sending multiple recipients in a Blind Carbon Copy (BCC) format for bulk mailing; setting video email user defined parameters specifying: 1. number of recipients bulked (grouped) together where value zero is regarded as all recipients; 2. number of seconds interval between each transmission ranging from 1 second to any value send of video email defines; 3. number of sequential bulk sent at any given time ranged from 1 to a preselected value specified by the video email sender; and 4. resetting the number of bulk sent after connection to a SMTP server, this value also preselected by the video email sender.

41. A method according to claim 40 further including the steps of creating confirmation of successful transmission of sent email; displaying errors of unsuccessful transmission of sent email along with its reasoning; and showing related statistics about sent video email.

42. A method according to claim 40 including the further steps of creating an automatic method for setting up video email settings by creating a step-by-step wizard helping video email sender to:
a. get introduced and acquainted to the procedure;
b. set up SMTP, POP3 and Authorized Email Addresses;
c. set up and verifying POP3 User Name, POP3 Password, and Reply Email Account;
d. customize the settings for the video email sender to:
1. not connect to POP3 Account;
2. log on to the SMTP Server using:
a. the same user name as the POP3 Account;
b. log on as a different user with different password;
e. finalize the settings by testing the parameters and verifying all accuracies; and
f. display any and all inaccuracies for video email sender correction.

43. A method for sending video email to recipients comprising the steps of:
i. generating video emails containing video, graphics and audio content;
ii. establishing an intelligent video streaming server;
iii. storing generated video emails in the intelligent video streaming server;
iv. determining in the intelligent video streaming server an intelligent scoring algorithm for playing the optimum settings of video for a video email recipient or a web browser;
v. establishing a gateway to access the intelligent video streaming server from an Internet browser or through a video email generator;
vi. setting up security settings for a plurality of users for access to content based on a predetermined level of authorization and access;
vii. defining each user's ability to access the secured site by properly entering user identification and password driven input identifying user's access to the site;
viii. allowing user managed, video, audio, animation, and images folders;
ix. allowing users to edit and change password settings by entering the old password, and entering the new password and confirming the new password once more; and
x. allowing video, audio and image formats defined by an Administrator assigning type of extension that would be permitted for uploading and streaming.

44. The method of claim 43 including the further step of allowing users to create limited video, audio, and image folders limited only to disk space.

45. The method of claim 43 including the further step of

46. The method of claim 43 including the further step of allowing renaming of video, audio, and imaging folders by preselected users.

47. The method of claim 43 including the further step of allowing users to determine the most optimal automatic playing decision criteria by using a scroll bar.

48. The method of claim 47 including the further step of defining the best video, audio and image viewing experience in form of scalable scroll bar that is measured from one extreme for best quality video versus another extreme for optimized downloading speed.

49. The method of claim 43 including the further step of displaying on a computer screen a control panel to enable a user to manage video, audio and image files stored in the intelligent video streaming server.

50. The method of claim 43 including the further step of including in the video emails an animation file.

51. The method of claim 50 including the further step of programming the video email so that the animation is displayed before the video, audio and image is displayed on a computer screen.

52. The method of claim 50 including the further step of programming the video email so that the animation is displayed in a way to compensate for streaming video hashing, streaming and latency.

53. The method of claim 43 including the further step of displaying on a computer screen usage showing allocated amount of disk space against the actual usage of disk space.

54. The method of claim 43 including the further step of

55. The method of claim 43 including the further step of storing multiple video contents based on different settings supported by media player formats including:
1. Microsoft Media Player
2. Real Networks Real One
3. Apple Quick Time
4. MPEG-1, 2, 4
5. Macromedia Flash

56. The method of claim 43 further including the step of converting a video content into several video, audio and image formats and storing them into video, audio, and image folders and storing in the intelligent video streaming server.

57. The method of claim 43 further including the step of establishing a secured upload of video, audio and image files.

58. The method of claim 43 further including the step of associating for video, audio, and image types based on supported media player formats for providing knowledge base to the algorithm of the intelligent video streaming server.

59. The method of claim 43 further including the step of automatically creating an intelligent detection computer code using input supplied by video format, bandwidth, and file extension and incorporating such knowledge into the video email video input field for assuring emailing the correct video.

60. The method of claim 43 further including the step of automatically creating an intelligent detection computer code for use in conjunction with any web site, for streaming intelligent video, audio, and animation based on measured bandwidth and video format.

61. The method of claim 43 further including the step of using decision criteria in the algorithm based on user decisions on quality of video versus speed of download to enable a web browser to display a video without regard to selecting the speed of connection, media format type, and change in personal computer desktop settings restrictions and preference.

62. The method of claim 43 wherein the algorithm determines quality versus speed and orders streaming for most suitable video, audio, and image for email recipient or web browsing streaming experience.

63. The method of claim 43 including the further steps of automatically creating an intelligent detection computer code residing at the intelligent video streaming server based on the algorithm detecting automatically the most suitable video streaming for emailing or viewing experience by assigning values to speed, bandwidth connection, media format and creating a “Certainty Factor” and wherein the highest computational variables so determined are associated with video format, connection speed, desktop settings and user preferences for streaming or emailing for viewing experience on a computer screen.

64. The method of claim 43 including the further steps of creating formats for web hosting wherein a web site owner can select for presentation one of intelligent pop-up video, audio, and image; using client desktop settings and media player; playing video from within a web page along side with other text and images and using computer language codes such as HTML, JavaScript, XML to display video, audio, and image.

65. A method of administrating a server comprising the steps of establishing an intelligent video streaming server; entering into intelligent video streaming server (IVSS) with administrative user identification and password; defining Base TCP Port Numbers; setting Home Directory for managing parties with different access levels; establishing a default storage disk space allocation as macro rule for an algorithm engine; using DNS registering ability at administrative choice with value defined by network and intelligent video streaming server administrative settings; defining a naming registry for secured access by administrator and registering such name with domain name registry (DNS); establishing a use of database format for storing party records; adding party-user identification, password access; assigning a specific port use to party or using a unique custom defined naming convention; creating a home directory where the video, audio, animation and images will reside; allowing file extensions where the use of video, audio, animation and images would be limited to those extensions granted by the Administration; establishing a disk space use for a party; and defining bandwidth allocation for parties where value of “−1” would provide unlimited bandwidth access.

66. A method according to claim 65 wherein a plurality of servers are set up and configured to establish the intelligent video streaming server.

67. A method according to claim 65 wherein base and authorized TCP Port Numbers are configured to work with firewall settings.

68. A method according to claim 65 wherein the default storage disk space is changeable to size to a party's requirement.

69. A method according to claim 65 wherein accessing the server for administrative control is established through a panel control system.

70. A method according to claim 65 wherein party information to intelligent video streaming server can be added, edited and deleted.

71. A method according to claim 65 including the further step of monitoring the use of active and inactive parties and the use of their allocated disk space and bandwidth.

72. A method according to claim 65 including the further step of establishing a default time-out where if administrative screen displayed on a computer screen is unattended, it would exit out and roll back to Administrative user identification, and password.

73. A method of storing a video on a server comprising the steps of establishing an intelligent video streaming server, accessing intelligent video streaming server through a standard web browser; including an algorithm engine in the intelligent video streaming server; entering party proper identification for accessing authorized location in server; creating folders by party for storing, video, audio, animation, and images; selecting a naming convention where the initial name starting with key identifier provides provision for algorithm engine learning video is meant for special broadcasting and emailing provision; selecting the second portion of the naming convention for informing algorithm engine of media player required for streaming or emailing; selecting the third portion of naming convention where of the naming sequence informs algorithm engine concerning the name of video for streaming or emailing; selecting the naming convention to inform algorithm engine about the video format required for streaming or emailing; incorporating the naming knowledge into algorithm engine and creating a computer generated code for display on a computer screen; creating automatic URL based code for use by party for video web hosting using intelligent video streaming server or placing it into video emailing system for delivering to email recipient.

74. A method for computing a user's best viewing protocol for an email generated video comprising the steps of defining a scoring system for viewing video format; supplying values of the scoring system to an algorithm engine for measuring highest probability values, “Certainty Factors”, selecting download speed and bandwidth connectivity as values for determining the Certainty Factor; for associating file format extension to a media player located at viewing computer settings with wrong media format association with a media player producing the least Certainty Factor and right media format association with right media player producing the highest Certainty Factor, creating decision criteria for sending the highest valued video for streaming or emailing by inserting Certainty Factor values into algorithm engine; and defining connection speed methodology where value is referred to as raw speed; creating a file size assessment computation where such value is referred to as bias factor; taking into account the raw speed and bias factor and defining a score setting using algorithm engine for the most suitable viewing on a computer screen.

75. The method of claim 74 including the further step of converting the values from the algorithm engine into machine code language for its placement into hosting web sites streaming from intelligent video streaming server.

76. The method of claim 74 including the further step of converting the values from the algorithm engine into machine code language for placement into video emailing for broadcasting to email recipient.

77. The method of viewing intelligent video for the Internet browser comprising the steps of invoking web browser program from a computer; being online through use of TCP/IP or Internet; entering a web site that uses an intelligent video streaming server for its video streaming; and clicking on an icon supplied by a party controlling the intelligent video to play the video.

78. A method for viewing intelligent video by an email recipient comprising the steps of; going online through use of TCP/IP or Internet; accessing a web based email programs hosted online that transmits intelligent video; signing on as an authorized user with password; sending and receiving email; and setting security option to “Internet” browsing.

79. Apparatus for generating a video email comprising:
a. means for providing a video for display on a computer screen;
b. means for providing a skin image for display on a computer screen;
c. means for correlating the video and the skin image positions in a pre-d.
d. means for selected matrix to display on a computer screen;
e. means for establishing a sender's email address;
f. means for establishing a subject heading for broadcasting a video email;
g. means for creating a link to the skin image and a link to the video for integrated access and uploading; and
h. means for creating the ability to fetch and display the skin image and the video for display on a computer screen of a recipient in the pre-selected matrix.

80. Apparatus of claim 79 wherein means are provided for storing the video at one of a streaming server, designated IP Address, and a web site.

81. Apparatus of claim 79 wherein the video is a file and means are provided to storing the video in a streaming server.

82. Apparatus of claim 79 wherein means are provided for storing the skin image at one of a streaming server, designated IP Address, and a web site.

83. Apparatus of claim 79 wherein means are provided for storing the video at one of a streaming server, designated IP Address, and a web site for integrated access and uploading.

84. Apparatus of claim 79 wherein means are provided for storing the video and the skin image at one of a streaming server, designated IP Address, and a web site for integrated access and uploading.

85. Apparatus of claim 79 wherein means are provided for creating an action label in form of text or image connecting to at least one of a link, email address, web page, and IP address.

86. Apparatus for placement of a skin image comprising: means for creating a link to a skin image file to establish an input defining the location of the skin image file on a computer screen; means for creating a link to one of an intelligent video streaming server, IP specific address and web site at which the skin image file is stored and located for integrated access and uploading of a skin image file to a computer screen of a recipient; means for establishing the ability to fetch and display the stored skin image file from its location; and means for creating the capability of changing the size of the fetched skin image on a computer screen to fit a user's need.

87. Apparatus for placement of a skin image according to claim 86 wherein the skin image is stored on an intelligent video streaming server.

88. Apparatus for placement of a skin image according to claim 86 including means for creating the capability of scrolling the skin image on a computer screen.

89. Apparatus for placement of a skin image according to claim 86 including means for creating an expandable rectangular box covering a specific area or all skin image surface for hyperlink to a URL address (Web site address).

90. Apparatus for placement of a skin image according to claim 86 wherein means are provided for creating the skin image in a plurality of skin image files.

91. Apparatus for placement of a skin image according to claim 90 wherein means are provided to establish a plurality of links to IP specific addresses or web sites for entering the location of the skin image files.

92. Apparatus for placement of a video clip comprising means for creating an email to which is associated a video clip and an image file, means for sending the email from an email sender to an email recipient and means for enabling the image file to be displayed and the video clip to be played automatically when the email arrives in the recipient's mailbox.

93. Apparatus for placement of a video clip according to claim 92 wherein the video clip is an attachment.

94. Apparatus for placement of a video clip according to claim 92 including means for playing the video clip automatically within the skin image file in a position defined on a computer screen by the email sender.

95. Apparatus for placement of a video clip according to claim 92 including means for playing the video clip automatically when the email recipient clicks on a designated area of the skin image file as defined by the email sender.

96. Apparatus for placement of a video clip according to claim 92 including means for popping up the video on a computer screen and playing automatically.

97. Apparatus for placement of a video clip according to claim 92 including means for establishing authorized authentication, direct connection, and video access through an intelligent video streaming server for uploading of a video file to the intelligent video streaming server.

98. Apparatus for placement of a video clip according to claim 97 including means for establishing an automated link and its automatic paste entry of video streaming code from the intelligent video streaming server into the video clip input field.

99. A method for placement of a video clip according to claim 92 including means for establishing an input link to at least one of an IP specific address, a streaming server and a web site where video file is located for entering designated location of video file(s).

100. Apparatus for placement of a video clip according to claim 92 including means for creating the ability for input link to video files based on formats available from Microsoft Media Player Format, Real Network's Real One Formats, Apple Quick Time Formats, Motion Picture Expert Group (MPEG) Formats, and Macromedia Flash Formats.

101. Apparatus for placement of a video clip according to claim 92 including means for establishing variable video formats for broadband and modem connection and broadcasting streamed from at least one of an intelligent video streaming server, a designated IP Address, a video streaming server and a web site.

102. Apparatus for importing email addresses comprising means for establishing a storage for storing emails; means for creating a user manual input of email accounts to create a database; means for establishing a test email account for testing and viewing an email account on a computer screen; means for importing email accounts from one of Plain Text, Microsoft Excel, Microsoft Access, Open Data Base Compliance (OBBC) data sources, Microsoft Outlook and Outlook Express, Microsoft Word, and other formats supporting ASCII files with and without delimiters for separating fields of information including name, address, email from one another to obtain email addresses; means for customizing step-by-step Wizard for Plain Text, ASCII, Excel, Access, and ODBC data source (automated program) for helping import of such data to be simple and easy; means for exporting such email list as Plain Text and ASCII file format for future ease of use and downloading into the storage for use in a video emailing system.

103. Apparatus for sending a video email comprising means for sending one video email per recipient; means for sending multiple recipients in a Blind Carbon Copy (BCC) format for bulk mailing to expedite sending; means for setting video email user defined parameters specifying: 1. number of recipients bulked (grouped) together where value zero is regarded as all recipients; 2. number of seconds interval between each transmission ranging from 1 second to any value send of video email defines; 3. number of sequential bulk sent at any given time ranged from 1 to a preselected value specified by the video email sender; and 4. resetting the number of bulk sent after connection to a after connection to a SMTP server, this value also preselected by the video email sender to facilitate sending.

104. Apparatus according to claim 103 further including means for creating confirmation of successful transmissions of sent email; displaying errors of unsuccessful transmissions of sent email along with its reasoning; and showing related statistics about sent video email.

105. Apparatus according to claim 103 including means for programming the video email with an animation that is displayed before the video, audio and image are displayed on a computer screen to cover the delay in display.

106. Apparatus according to claim 105 wherein the animation is displayed in a way to compensate for streaming video hashing, streaming and latency.

107. Apparatus according to claim 103 including means for storing multiple video contents based on different settings supported by media player formats including:
1. Microsoft Media Player
2. Real Networks Real One
3. Apple Quick Time
4. MPEG-1, 2, 4
5. Macromedia Flash
to enable a better choice of player format.

108. Apparatus according to claim 103 including means for converting a video content into several video, audio and image formats to provide versatility and means for incorporating them into video, audio, and image folders for easier access and means for storing the folders in the intelligent video streaming server to enable quick fetching.

109. Apparatus according to claim 103 including means for associating for video, audio, and image types based on supported media player formats for providing knowledge base to an algorithm of an intelligent video streaming server.

110. Apparatus according to claim 103 including means for automatically creating an intelligent detection computer code using input supplied by video format, bandwidth, and file extension and incorporating such knowledge into the video email video input field for assuring emailing the correct video.

111. Apparatus according to claim 103 including means for automatically creating an intelligent detection computer code for use in conjunction with any web site, for streaming intelligent video, audio, and animation based on measured bandwidth and video format.

112. Apparatus according to claim 103 including means for using decision criteria in an algorithm based on user decisions on quality of video versus speed of download to enable a web browser to display a video without regard to selecting the speed of connection, media format type, and change in personal computer desktop settings restrictions and preference.

113. Apparatus according to claim 112 wherein the algorithm determines quality versus speed and orders streaming for most suitable video, audio, and image for email recipient or web browsing streaming experience.

114. Apparatus according to claim 112 including means for automatically creating an intelligent detection computer code residing at the intelligent video streaming server based on the algorithm detecting automatically the most suitable video streaming for emailing or viewing experience by assigning values to speed, bandwidth connection, media format and creating a “Certainty Factor” and wherein the highest computational variables so determined are associated with video format, connection speed, desktop settings and user preferences for streaming or emailing for viewing experience on a computer screen.

115. Apparatus for administrating a server comprising means for establishing an intelligent video streaming server for administration; means for entering into intelligent video streaming server (IVSS) with administrative user identification and password; defining Base TCP Port Numbers for controlling the server; means for setting Home Directory for managing parties with different access levels to control server use; means for establishing a default storage disk space allocation as macro rule for an algorithm engine to control algorithm activity; means for using DNS registering ability at administrative choice with value defined by network and intelligent video streaming server administrative settings for administrating the server; means for defining a naming registry for secured access by administrator and registering such name with domain name registry (DNS) to restrict access to the server; means for establishing a use of database format for storing party records for organization; means for adding party-user identification, password access; assigning a specific port use to party or using a unique custom defined naming convention to control access; means for creating a home directory where the video, audio, animation and images will reside to establish storage; means for allowing file extensions where the use of video, audio, animation and images would be limited to those extensions granted by the Administration for controlling stored videos; means for establishing a disk space use for a party for the party's convenience; and means for defining bandwidth allocation for parties where value of “−1” would provide unlimited bandwidth access to control access.

116. Apparatus according to claim 115 wherein a plurality of servers are set up and configured to establish the intelligent video streaming server.

117. Apparatus according to claim 115 including means for monitoring the use of active and inactive parties and the use of their allocated disk space and bandwidth for controlling party's use.

118. Apparatus for storing a video on a server comprising an intelligent video streaming server, means for accessing intelligent video streaming server through a standard web browser to gain access; an algorithm engine included in the intelligent video streaming server; means for entering party proper identification for accessing authorized location in server for gaining access; means for creating folders by party for storing, video, audio, animation, and images on server; means for selecting a naming convention where the initial name starting with key identifier provides provision for algorithm engine learning video is meant for special broadcasting and emailing provision; means for selecting the second portion of the naming convention for informing algorithm engine of media player required for streaming or emailing; means for selecting the third portion of naming convention for informing algorithm engine concerning the name of video for streaming or emailing; means for selecting the naming convention to inform algorithm engine about the video format required for streaming or emailing; means for incorporating the naming knowledge into algorithm engine and creating a computer generated code for display on a computer screen; means for creating automatic URL based code for use by party for video web hosting using intelligent video streaming server or placing it into video emailing system for delivering to email recipient.

119. Apparatus for computing a user's best viewing protocol for an email generated video comprising means for defining a scoring system for viewing video format as a basis of decision; means for supplying values of the scoring system to an algorithm engine for measuring highest probability values, “Certainty Factors”; means for selecting download speed and bandwidth connectivity as values for determining the Certainty Factor; for associating file format extension to a media player located at viewing computer settings, with wrong media format association with a media player producing the least Certainty Factor, and right media format association with right media player producing the highest Certainty Factor, means for creating decision criteria for sending the highest valued video for streaming or emailing by inserting Certainty Factor values into algorithm engine; and means for defining connection speed methodology where value is referred to as raw speed; creating a file size assessment computation where such value is referred to as bias factor; taking into account the raw speed and bias factor and defining a score setting using algorithm engine for determining the most suitable viewing on a computer screen.

120. Apparatus according to claim 119 including means for converting the values from the algorithm engine into machine code language for placement into hosting web sites streaming from intelligent video streaming server to enable best viewing.

121. Apparatus according to claim 119 including means for converting the values from the algorithm engine into machine code language for placement into video emailing for broadcasting to email recipient to enable best viewing.
